(19) United States
(12) Patent Application Publication
(10) Pub. No.: US 2025/0182028 A1
(43) Pub. Date: Jun. 5, 2025

(54) GOAL-BASED INTELLIGENT ENGINE

(71) Applicant: The Toronto-Dominion Bank, Toronto (CA)

(72) Inventor: Breena Patricia Gormley, Toronto (CA)

(73) Assignee: The Toronto-Dominion Bank, Toronto, ON (CA)

(21) Appl. No.: 18/528,569

(22) Filed: Dec. 4, 2023

(51) Int. Cl. G06Q 10/0637; G06N 20/00

(52) U.S. Cl. CPC G06Q 10/0637; G06N 20/00

(57) ABSTRACT

An example operation may include one or more of ingesting profile data from one or more websites via one or more application programming interfaces (APIs) and storing the profile data within a data store, displaying one or more prompts on a user interface of a user profile page within a software application hosted by a host platform, receiving one or more responses to the one or more prompts, determining a goal for a user of the user profile page based on execution of an artificial intelligence (AI) model on the profile data, the one or more prompts, and the one or more responses to the one or more prompts, and displaying an identifier of the goal via the user interface of the user profile page of the software application.

### BACKGROUND

Studies have shown that a visual representation of a goal can help a user visualize and achieve that goal better than without such visual representation. Achieving goals requires determination and focus. A visualization of a goal can help a person clearly understand the goal and get motivated about the goal thereby enabling them more determination and more focus toward the goal.

### SUMMARY

One example embodiment provides an apparatus that may include a memory and a processor communicably coupled to the memory, the processor configured to perform one or more of ingest data from one or more websites via one or more application programming interfaces (APIs) and store the data within a data store of a host platform, display one or more prompts on a user interface of a user profile page within a software application hosted by the host platform, receive one or more responses to the one or more prompts, generate a travel itinerary based on execution of an artificial intelligence (AI) model on the data from the one or more websites, the one or more prompts, and the one or more responses, and display the travel itinerary via the user interface of the user profile page of the software application.

Another example embodiment provides a method that includes one or more of ingesting data from one or more websites via one or more application programming interfaces (APIs) and storing the data within a data store of a host platform, displaying one or more prompts on a user interface of a user profile page within a software application hosted by the host platform, receiving one or more responses to the one or more prompts, generating a travel itinerary based on execution of an artificial intelligence (AI) model on the data from the one or more websites, the one or more prompts, and the one or more responses, and displaying the travel itinerary via the user interface of the user profile page of the software application.

A further example embodiment provides a computer-readable storage medium comprising instructions stored therein which when executed by a processor cause the processor to perform one or more of ingesting data from one or more websites via one or more application programming interfaces (APIs) and storing the data within a data store of a host platform, displaying one or more prompts on a user interface of a user profile page within a software application hosted by the host platform, receiving one or more responses to the one or more prompts, generating a travel itinerary based on execution of an artificial intelligence (AI) model on the data from the one or more websites, the one or more prompts, and the one or more responses, and displaying the travel itinerary via the user interface of the user profile page of the software application.

Another example embodiment provides an apparatus that may include a memory and a processor communicably coupled to the memory, the processor configured to perform one or more of ingest data from one or more websites via one or more application programming interfaces (APIs) and store the data within a data store of a host platform, generate one or more prompts and display the one or more prompts on a user interface of a user profile page within a software application hosted by the host platform, receive one or more responses to the one or more prompts; generate a design of a structure based on execution of an artificial intelligence (AI) model on the data from the one or more websites, the one or more prompts, and the one or more responses, and display the design of the structure via the user interface of the user profile page of the software application.

Another example embodiment provides a method that includes one or more of ingesting data from one or more websites via one or more application programming interfaces (APIs) and storing the data within a data store of a host platform, generating one or more prompts and displaying the one or more prompts on a user interface of a user profile page within a software application hosted by the host platform, receiving one or more responses to the one or more prompts, generating a design of a structure based on execution of an artificial intelligence (AI) model on the data from the one or more websites, the one or more prompts, and the one or more responses, and displaying the design of the structure via the user interface of the user profile page of the software application.

A further example embodiment provides a computer-readable storage medium comprising instructions stored therein which when executed by a processor cause the processor to perform one or more of ingesting data from one or more websites via one or more application programming interfaces (APIs) and storing the data within a data store of a host platform, generating one or more prompts and displaying the one or more prompts on a user interface of a user profile page within a software application hosted by the host platform, receiving one or more responses to the one or more prompts, generating a design of a structure based on execution of an artificial intelligence (AI) model on the data from the one or more websites, the one or more prompts, and the one or more responses, and displaying the design of the structure via the user interface of the user profile page of the software application.

Another example embodiment provides an apparatus that may include a memory and a processor communicably coupled to the memory, the processor configured to perform one or more of ingest profile data from one or more websites via one or more application programming interfaces (APIs) and store the profile data within a data store, display one or more prompts on a user interface of a user profile page within a software application hosted by a host platform, receive one or more responses to the one or more prompts, determine a goal for a user of the user profile page based on execution of an artificial intelligence (AI) model on the profile data, the one or more prompts, and the one or more responses to the one or more prompts, and display an identifier of the goal via the user interface of the user profile page of the software application.

Another example embodiment provides a method that includes one or more of ingesting profile data from one or more websites via one or more application programming interfaces (APIs) and storing the profile data within a data store, displaying one or more prompts on a user interface of a user profile page within a software application hosted by a host platform, receiving one or more responses to the one or more prompts, determining a goal for a user of the user profile page based on execution of an artificial intelligence (AI) model on the profile data, the one or more prompts, and the one or more responses to the one or more prompts, and displaying an identifier of the goal via the user interface of the user profile page of the software application.

A further example embodiment provides a computer-readable storage medium comprising instructions stored therein which when executed by a processor cause the processor to perform one or more of ingesting profile data from one or more websites via one or more application programming interfaces (APIs) and storing the profile data within a data store, displaying one or more prompts on a user interface of a user profile page within a software application hosted by a host platform, receiving one or more responses to the one or more prompts, determining a goal for a user of the user profile page based on execution of an artificial intelligence (AI) model on the profile data, the one or more prompts, and the one or more responses to the one or more prompts, and displaying an identifier of the goal via the user interface of the user profile page of the software application.

Another example embodiment provides an apparatus that may include a memory and a processor communicably coupled to the memory, the processor configured to perform one or more of train an artificial intelligence (AI) model to recommend numerical goals based on execution of the AI model on historical profile data and contextual data that is associated with the historical profile data, store profile data of a user profile within a data store of a software application, receive a request via a user interface of a user profile page of the software application, wherein the request comprises context of a user of the user profile, determine a numerical goal for the user profile based on execution of the AI model on the profile data of the user profile and the context, and display the numerical goal via the user interface of the user profile page within the software application.

Another example embodiment provides a method that includes one or more of training an artificial intelligence (AI) model to recommend numerical goals based on execution of the AI model on historical profile data and contextual data that is associated with the historical profile data, storing profile data of a user profile within a data store of a software application, receiving a request via a user interface of a user profile page of the software application, wherein the request comprises context of a user of the user profile, determining a numerical goal for the user profile based on execution of the AI model on the profile data of the user profile and the context, and displaying the numerical goal via the user interface of the user profile page within the software application.

A further example embodiment provides a computer-readable storage medium comprising instructions stored therein which when executed by a processor cause the processor to perform one or more of training an artificial intelligence (AI) model to recommend numerical goals based on execution of the AI model on historical profile data and contextual data that is associated with the historical profile data, storing profile data of a user profile within a data store of a software application, receiving a request via a user interface of a user profile page of the software application, wherein the request comprises context of a user of the user profile, determining a numerical goal for the user profile based on execution of the AI model on the profile data of the user profile and the context, and displaying the numerical goal via the user interface of the user profile page within the software application.

### BRIEF DESCRIPTION OF THE DRAWINGS

FIG. 1 is a diagram illustrating an artificial intelligence (AI) computing environment for generating content associated with user input and outputting the content associated with the input according to example embodiments.

FIG. 2 is a diagram illustrating a process of executing a predictive model on input content according to example embodiments.

FIGS. 3A-3C are diagrams illustrating processes for training an artificial intelligence (AI) model according to example embodiments.

FIG. 4 is a diagram illustrating a process of prompting an AI model to generate custom content according to example embodiments.

FIGS. 5A-5C are diagrams illustrating a process of generating a travel itinerary via artificial intelligence according to example embodiments.

FIGS. 6A-6B are diagrams illustrating a feedback process for retraining an AI model according to example embodiments.

FIGS. 7A-7C are diagrams illustrating a process of generating a design of a structure according to example embodiments.

FIGS. 8A-8B are diagrams illustrating a process of generating a description of a goal according to example embodiments.

FIGS. 9A-9D are diagrams illustrating a process of generating a numerical goal for a user according to example embodiments.

FIG. 10A is a diagram illustrating a method of generating a travel itinerary through artificial intelligence according to example embodiments.

FIG. 10B is a diagram illustrating a method of generating a structural design through artificial intelligence according to example embodiments.

FIG. 10C is a diagram illustrating a method of generating a description of a goal according to example embodiments.

FIG. 10D is a diagram illustrating a method of generating a numerical goal according to example embodiments.

FIG. 11A is a diagram illustrating a method of generating a travel itinerary through artificial intelligence according to example embodiments.

FIG. 11B is a diagram illustrating a method of generating a structural design through artificial intelligence according to example embodiments.

FIG. 11C is a diagram illustrating a method of generating a description of a goal according to example embodiments.

FIG. 11D is a diagram illustrating a method of generating a numerical goal according to example embodiments.

FIG. 12A is a flow diagram according to example embodiments.

FIG. 12B is another flow diagram according to example embodiments.

FIG. 12C is another flow diagram according to example embodiments.

FIG. 12D is another flow diagram according to example embodiments.

FIG. 13 is a diagram illustrating a computing system that may be used in any of the example embodiments described herein.

### DETAILED DESCRIPTION

It is to be understood that although this disclosure includes a detailed description of cloud computing, implementation of the instant solution recited herein is not limited to a cloud computing environment. Rather, embodiments of the instant solution are capable of being implemented in conjunction with any other type of computing environment now known or later developed.

The instant solution may be implemented in conjunction with computing environments involving technology classified under one or more of the artificial intelligence (AI) classifications and/or AI models, known now or later developed. Technological advancements typically build upon the fundamentals of predecessor technologies, such is the case with AI models. An AI classification system describes the stages of AI progression. The first classification is known as “Reactive Machines,” followed by present-day AI classification “Limited Memory Machines” (also known as “Artificial Narrow Intelligence”), then progressing to “Theory of Mind” (also known as “Artificial General Intelligence”) and reaching the AI classification “Self Aware” (also known as “Artificial Superintelligence”). Present-day Limited Memory Machines are a growing group of AI models built upon the foundation of its predecessor, Reactive Machines. Reactive Machines emulate human responses to stimuli; however, they are limited in their capabilities as they cannot typically learn from prior experience. Once the AI model's learning abilities emerged, its classification was promoted to Limited Memory Machines. In this present-day classification, AI models learn from large volumes of data, detect patterns, solve problems, generate and predict data, and the like, while inheriting all of the capabilities of Reactive Machines. Examples of AI models classified as Limited Memory Machines include, but are not limited to, Chatbots, Virtual Assistants, Machine Learning (ML), Deep Learning (DL), Natural Language Processing (NLP), Generative AI (GenAI) models, and any future AI models that are yet to be developed possessing the characteristics of Limited Memory Machines. Generative AI models are a combination of Limited Memory Machine technologies, incorporating ML and DL, and, in turn, form the foundational building blocks of future AI models. For example, Theory of Mind is the next progression of AI that will be able to perceive, connect, and react by generating appropriate reactions in response to the entity with which the AI model is interacting; all of these capabilities rely on the fundamentals of Generative AI. Furthermore, in an evolution into the Self Aware classification, AI models will be able to understand and evoke emotions in the entities they interact with, as well as possessing their own emotions, beliefs, and needs, all of which rely on Generative AI fundamentals of learning from experiences to generate and draw conclusions about itself and its surroundings. Generative AI models are integral and core to future artificial intelligence models. As described herein, AI models refers to present-day Generative AI models, present-day AI models, as well as future Generative AI models and AI models.

The example embodiments of the instant solution are directed to a process of generating a design of a goal such as a design of a dream home, a design of a vacation or other trip, a description of a goal, a numerical goal, and the like. The design may be generated and updated by an AI model. In some embodiments, the AI model may be a generative AI model such as a large language model (LLM) or the like. The generated design may include image content, text content, links, properties, and the like, which are generated by the AI model based on its training. In addition, the AI model may modify the design based on feedback from a user. For example, the instant solution may output queries to the user, receive responses to the queries, and use the queries and the responses to further refine the generated design. In this example, the original design, the queries, and the responses may be input to the AI model to further refine the generated design based on the feedback from the user.

Furthermore, the design can be modified by the user and transferred to other users. The design may be in a tangible format. For example, the design may be formatted as a digital document, a web page, a combination of web pages, a ticket (e.g., an airplane ticket, a train ticket, a bus pass, etc.), and the like. The design may be transferred to a user profile page of the user for whom the design is generated. Here, the design may be displayed within a window or other module associated with the user profile page.

According to various embodiments, the AI model may be a large language model such as a multimodal large language model. As another example, the AI model may be a transformer neural network (“transformer”), or the like. The AI model is capable of understanding images about an object or multiple types of objects. For example, the AI model may be trained on a large corpus of images associated with structures, travel itineraries, descriptions of goals, numerical goals, and the like. Here, the AI model may be able to generate new content based on the ingested content learned during the training. For example, the AI model may include libraries and deep learning frameworks that enable the AI model to create images, travel itineraries, tickets, text content, web pages, links, and the like, which are then embedded into a transferrable medium and sent to the user.

The AI model may generate text, images, a combination of both, and the like. For image-based designs, in some embodiments, the design that is generated may be a three-dimensional (3D) image of a tangible item such as a home, a beach, a mountain, a destination, and the like. In this example, the instant solution may provide an augmented reality (AR) viewing tool, a virtual reality (VR) viewing tool, or the like, which enables the user/viewer to further view the design in 3D space. For example, the user can move a field of view around the design to get a better view of the different parts, aspects, etc. of the design that may not be visible in two dimensions.

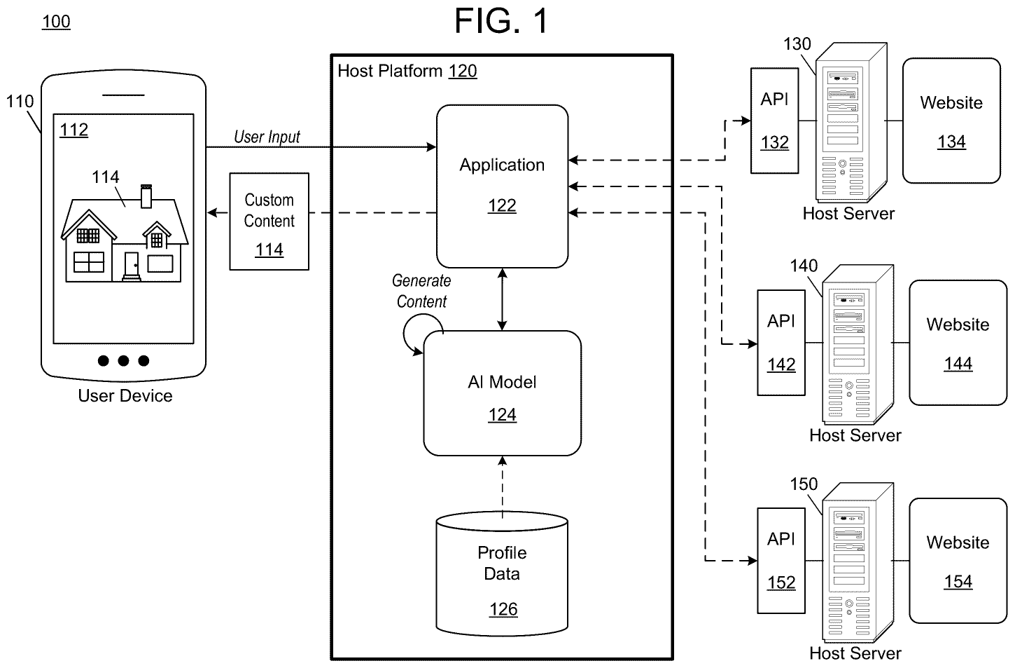

FIG. 1 illustrates an artificial intelligence (AI) computing environment 100 for generating content associated with user input, such as a goal, and outputting the content associated with the input according to example embodiments. Referring to FIG. 1, the AI computing environment 100 includes a host platform 120 that hosts a software application 122 such as a mobile application, progressive web application (PWA), on-premises application, and/or the like. In addition, the host platform 120 also hosts an AI model 124 that is capable of determining goals and generating visual content that depict the determined goals according to example embodiments.

For example, the AI model 124 may generate images, text, links, travel itinerary, documents, etc. based on a corpus of web pages that are ingested by the AI model 124. The web pages may be ingested from one or more websites. As another example, the AI model 124 may ingest a user profile from a profile data store 126. In the example of FIG. 1, the software application 122 queries a plurality of websites 134, 144, and 154, hosted by a plurality of servers 130, 140, and 150, respectively. Here, the software application 122 may generate queries for the web pages and send them to a plurality of APIs 132, 142, and 152, of the plurality of websites 134, 144, and 154, to retrieve content for ingestion by the AI model 124. Here, the software application 122 may use a plurality of credentials to establish a plurality of secure communication channels between the host platform 120 and the plurality of servers 130, 140, and 150, prior to retrieving the user profile data from the plurality of websites 134, 144, and 154. The establishment of a secure channel may be performed using an authentication scheme such as two-factor authentication, multi-factor authentication, biometric authentication, password entry, PIN entry, and the like.

The AI model 124 may generate unique images and descriptions based on the images and descriptions within the web pages, documents, and the like, which are obtained from the plurality of servers 130, 140, and 150. In addition, the AI model 124 may ingest profile data from a user profile (or multiple user profiles) of the software application 122. The user profiles may include account history data, current balances, personal information of the user and/or the user's family, and the like. The profile data may be used to identify purchase goals of users and the timeline for the goals. The profile data can further be used by the AI model 124 to determine and/or recommend travel arrangements, goals, numbers, and the like.

In the example of FIG. 1, the AI model 124 receives user input such as text content that is submitted from a user interface 112 of a user device 110. The text content is sent to the software application 122. In response, the software application 122 forwards the text content to the AI model 124 which executes on the text content and generates custom content 114 such as an image, text, travel itinerary, structural design, description, and/or the like. Furthermore, the custom content 114 can be generated by and output from the software application 122 and rendered on the user interface 112 of the user device 110.

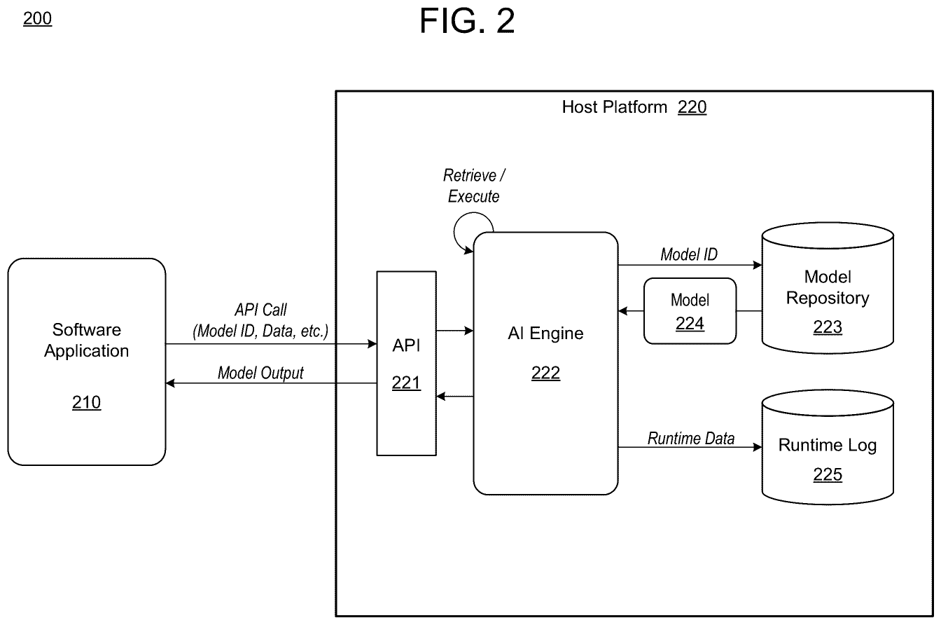

FIG. 2 illustrates a process 200 of executing a model 224 on input content according to example embodiments. As an example, the model 224 may be the AI model, however, embodiments are not limited thereto. Referring to FIG. 2, a software application 210 may request execution of the model 224 by submitting a request to the host platform 220. In response, an AI engine 222 may receive the request and trigger the model 224 to execute within a runtime environment of the host platform 220.

In FIG. 2, the AI engine 222 may control access to models that are stored within the model repository 223. For example, the models may include AI models, generative AI models, machine learning models, neural networks, LLMs, and/or the like. The software application 210 may trigger execution of the model 224 from the model repository 223 by invoking an API 221 of the AI engine 222. The request may include an identifier (ID) of the model 224 such as a unique ID assigned by the host platform 220, a payload of data (e.g., to be input to the model during execution), and the like. The AI engine 222 may retrieve the model 224 from the model repository 223 in response and deploy the model 224 within a live runtime environment. After the model is deployed, the AI engine 222 may execute the running instance of the model 224 on the payload of data and return a result of the execution to the software application 210.

In some embodiments, the payload of data may be a format that is not capable of being input to the model 224 nor read by a computer processor. For example, the payload of data may be in text format, image format, audio format, and the like. In response, the AI engine 222 may convert the payload of data into a format that is readable by the model 224 such as a vector or other encoding. The vector may then be input to the model 224.

In some embodiments, the software application 210 may display a user interface which enables a user thereof to provide feedback about the output provided by the model 224. For example, a user may input a confirmation about an image/non-fungible token (NFT) generated by a generative AI model. This information may be added to the results of execution and stored within a log 225. The log 225 may include an identifier of the input, an identifier of the output, an identifier of the model used, and feedback from the recipient. This information may be used to subsequently retrain the model.

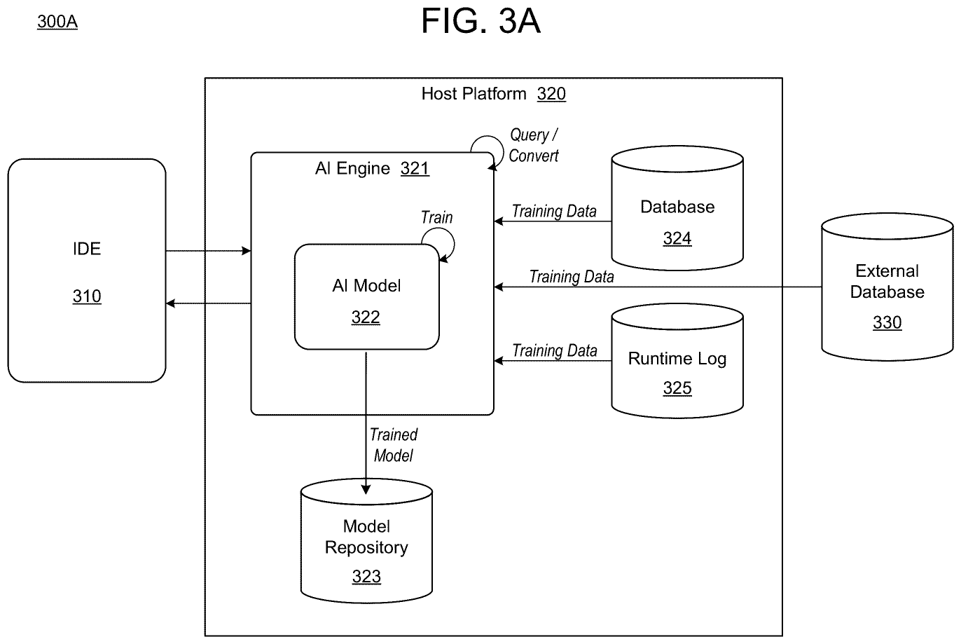

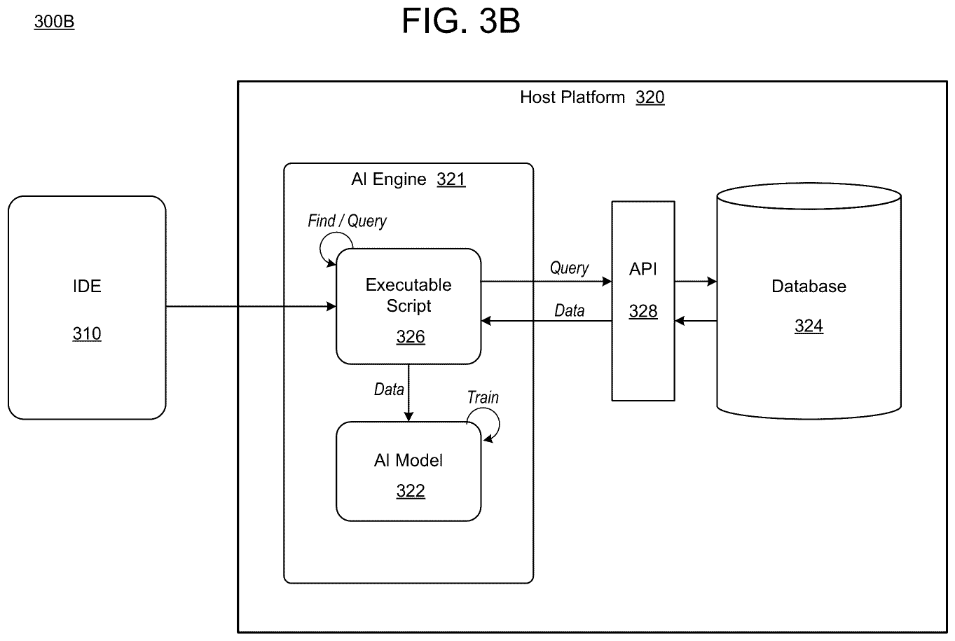

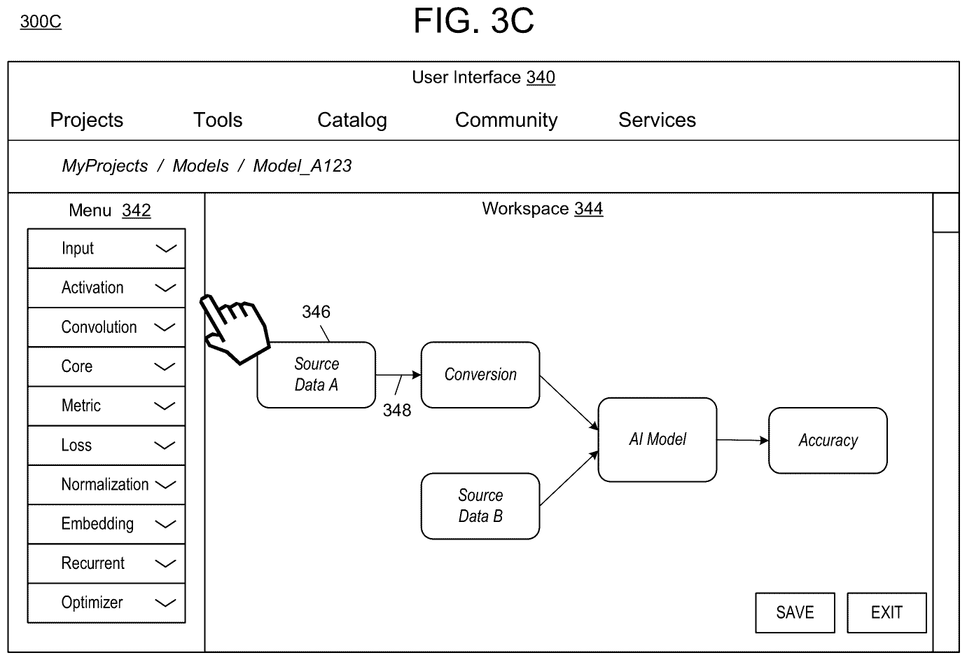

FIG. 3A illustrates a process 300A of training an AI model 322 according to example embodiments. However, it should be appreciated that the process 300A shown in FIG. 3A is also applicable to other types of models such as machine learning models and the like. Referring to FIG. 3A, a host platform 320 may host an integrated development environment (IDE) 310 where AI models, machine learning models, generative AI models, and the like may be developed, trained, retrained, and the like. In this example, the IDE 310 may include a software application with a user interface accessible by a user device over a network or through a local connection. For example, the IDE 310 may be embodied as a web application that can be accessed at a network address, uniform resource locator (URL), etc., by a device. As another example, the IDE 310 may be locally or remotely installed on a computing device used by a user.

The IDE 310 may be used to design a model (via a user interface of the IDE), such as a generative artificial intelligence model that can receive text as input and generate custom imagery, etc. The model can then be executed/trained based on the training data established via the user interface. For example, the user interface may be used to build a new model. The training data for training such a new model may be provided from a training data store such as a database 324 which includes training samples from the web, from customers, and the like. As another example, the training data may be pulled from one or more external data stores 330 such as publicly available sites, etc.

During training, the AI model 322 may be executed on training data via an AI engine 321 of the host platform 320. In the example embodiments, the training data may include a large corpus of images. In some cases, the images may be dedicated to a particular topic (e.g., trees, etc.). The AI model 322 may learn mappings/connections between requirements associated with images and goals created by a user. When the model is fully trained, it may be stored within the model repository 323 via the IDE 310, or the like.

As another example, the IDE 310 may be used to retrain the AI model 322 after the model has already been deployed. Here, the training process may use executional results that have already been generated/output by the AI model 322 in a live environment (including any customer feedback, etc.) to retrain the AI model 322. For example, predicted outputs/images that are custom generated by the AI model 322 and the user feedback of the images may be used to retrain the model to further enhance the images that are generated for all users. This data may be captured and stored within a runtime log 325 or other data store within the live environment and can be subsequently used to retrain the AI model 322.

FIG. 3B illustrates a process 300B of executing a process for training/retraining the AI model 322 via an AI engine 321. In this example, an executable script 326 is developed to read data from a database 324 and input the data to the AI model 322 while the AI model is running/executing via the AI engine 321. For example, the script 326 may use identifiers (IDs) of data locations (e.g., table IDs, row IDs, column IDs, topic IDs, object IDs, etc.) to identify locations of the training data within the database 324 and query an API 328 of the database 324. In response, the database 324 may receive the query, load the requested data, and return the data to the script 326 where it is input to the AI model 322. The process may be managed via a user interface of the IDE 310 allowing for supervised learning during the training process. However, it should also be appreciated that the instant solution is capable of unsupervised learning as well.

The script 326 may iteratively retrieve additional training data sets from the database 324 and iteratively input the additional training data sets into the AI model 322 during the execution of the AI model 322 to continue to train the AI model 322. The script may continue the process until instructions within the script 326 direct the script 326 to terminate which may be based on a number of iterations (training loops), total time elapsed during the training process, etc.

FIG. 3C illustrates a process 300C of designing a new AI model via a user interface 340 according to example embodiments. As an example, the user interface 340 may be output as part of the software application which interacts with the IDE 310 shown in FIG. 3A, however, embodiments are not limited thereto. Referring to FIG. 3C, a user can use an input mechanism to make selections from a menu 342 shown on the left-hand side of the user interface 340 to add pieces to the model such as data components, model components, analysis components, etc. within a workspace 344 of the user interface 340.

In the example of FIG. 3C, the menu 342 includes a plurality of graphical user interface (GUI) menu options which can be selected to reveal additional components that can be added into the model design shown in the workspace 344. Here, the GUI menu options include options for adding features such as neural networks, machine learning models, AI models, data sources, conversion processes (e.g., vectorization, encoding, etc.), analytics, etc. The user can continue to add features to the model and connect them using edges or other means to create a flow within the workspace 344. For example, the user may add a node 346 to a flow of a new model within the workspace 344. For example, the user may connect the node 346 to another node in the flow via an edge 348 creating a dependency within the flow. When the user is done, the user can save the model for subsequent training/testing.

According to various embodiments, the AI model described herein may be trained based on custom defined prompts that are designed to extract specific attributes associated with a unique/custom goal and/or design that is to be generated for a user. These same prompts may be output during live execution of the AI model. For example, a user may input a description of a goal such as a financial amount that needs to be saved and an identifier of the item. The requirements can then be used by the AI model to generate content (e.g., images, text, documents, tickets, web pages, etc.) which represent the goal. The prompts may be generated via prompt engineering that can be performed through the model training process such as the model training process described above in the examples of FIGS. 3A-3C.

Prompt engineering is the process of structuring sentences (prompts) to be understood by an AI model and refining the prompts to generate optimal outputs from the AI model. A prompt may ask for and receive a description of a goal. The text may be input to the AI model and used to create a new unique image and/or description. Part of the prompting process may include delays/waiting times that are intentionally included within the script such that the model has time to understand and process the input data.

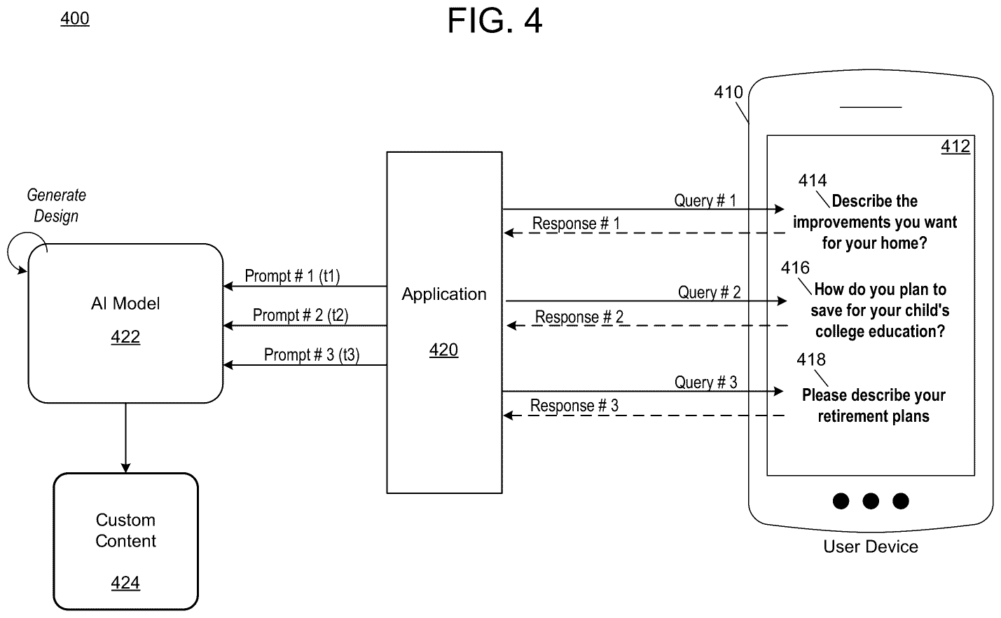

FIG. 4 illustrates a process 400 of an AI model 422 generating custom content 424 based on prompts and responses to the prompts according to example embodiments. Referring to the example of FIG. 4, the AI model 422 may be hosted by a host platform and may be part of a software application 420 that is also hosted on the host platform. Here, the software application 420 may establish a connection, such as a secure network connection, with a user device 410. The secure connection may involve a personal identification number (PIN), biometric scan, password, username, transport layer security (TLS) handshake, etc.

In the example of FIG. 4, the software application 420 may control the interaction of the AI model 422 on the host platform and the user device 410. In this example, the software application 420 may output queries 414, 416, and 418 on a user interface 412 of the user device 410 with requests for information from the user. In response to the queries 414, 416, and 418, the user may enter values into the fields on the user interface corresponding to the queries, and submit/transfer the data to the software application 420, for example, by pressing a submit button, etc. In this example, the application may combine the query with the response from the user interface and generate a prompt that is submitted to the AI model 422. For example, each prompt may include a combination of a query on the UI and the response from the user. For example, if the query is “at what age would you like to retire” and the response is “seventy years old”, then the text from both the query and the response to the query may be submitted to the AI model 422.

In some embodiments, the software application 420 may deliberately add waiting times between submitting prompts to the AI model 422 to ensure that the model has enough time to understand and process the input. The waiting times may be integrated into the code of the software application 420 or they may be modified/configured via a user interface. Furthermore, the ordering of the prompts and the follow-up queries that are asked may be different depending on the responses given during the previous prompt or prompts. The content within the prompts and the ordering of the prompts can cause the AI model 422 to generate custom content 424, such as images, text, travel itinerary, structural design, description, or the like.

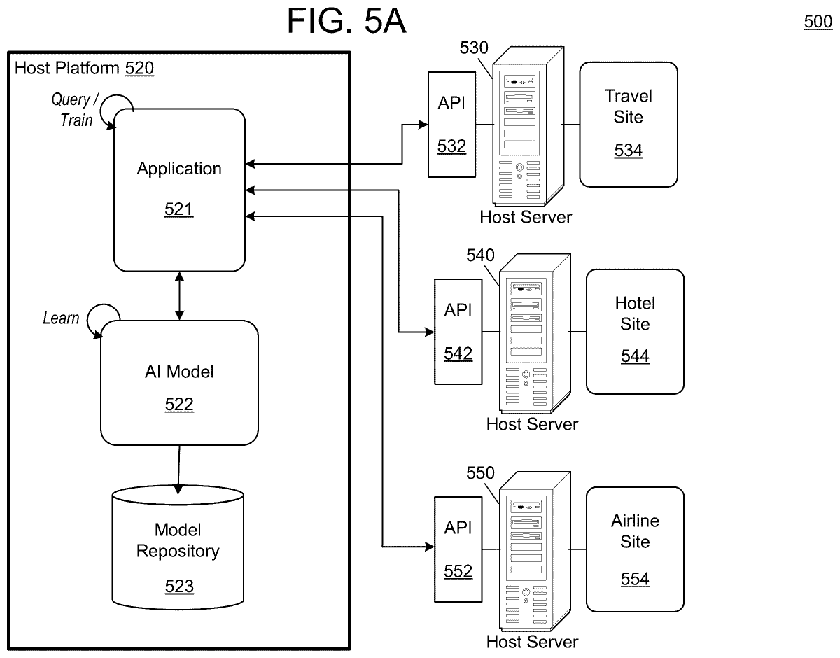

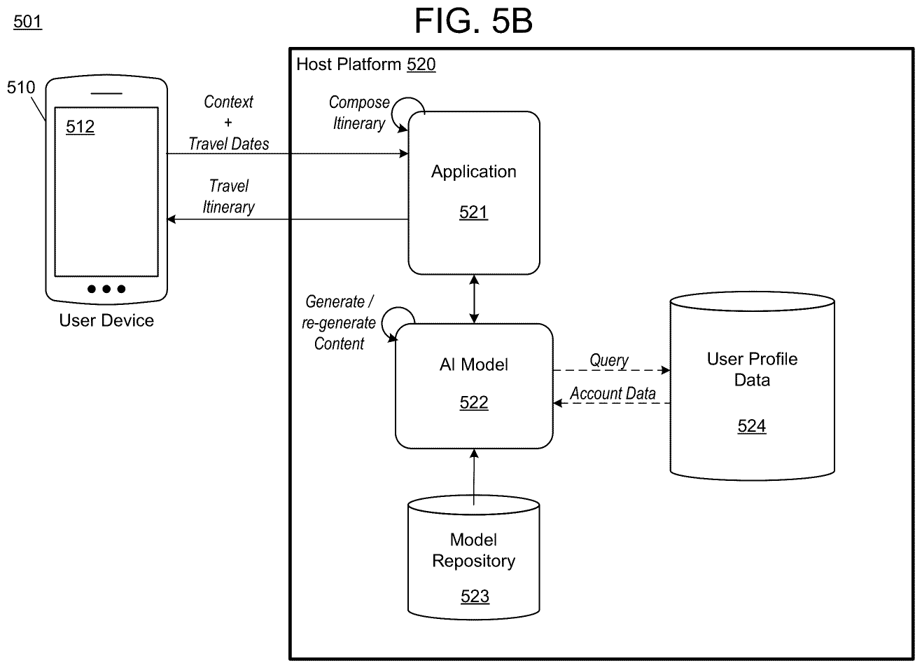

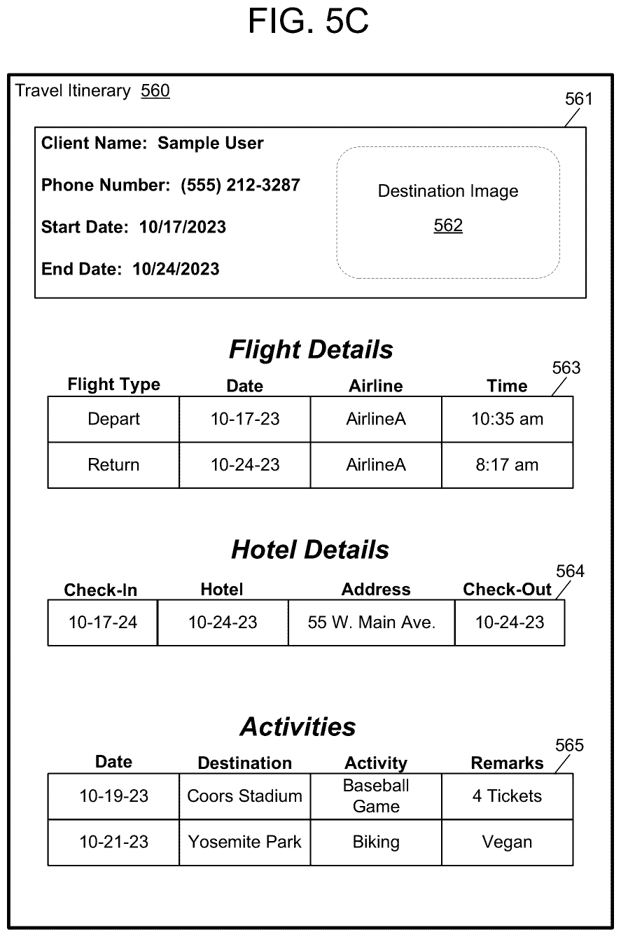

FIGS. 5A-5C illustrates a process of generating a travel itinerary via artificial intelligence according to example embodiments. According to various embodiments, the process may include using an AI model trained on ingested website data gathered through APIs, along with user prompts and their responses, to generate a travel itinerary. The generated itinerary is then displayed on a user interface within a software application. In this solution, the AI model sources data from various travel-related websites, accessing their data repositories through APIs. The APIs allow the solution to extract a diverse range of information like flight details, hotel reservations, local attractions, rental services, and more, ensuring that the AI model has a comprehensive understanding of travel-related data.

Once the data is acquired, the data may be used to train an AI model. The model learns patterns, relationships, and structures inherent in the data, allowing it to generate new, coherent, and contextually relevant information, such as creating a structured travel itinerary based on user inputs. Users interact with the instant solution by inputting their travel preferences, constraints, and requirements through a user interface which can be delivered to the AI model as prompts. The prompts can include queries asked of the user and responses from the user such as preferred travel dates, destinations, budget constraints, interest areas like beaches, mountains, or cities, and other specific needs or requests. The AI model takes these inputs and processes them to generate a travel itinerary that aligns with the user's specifications.

For example, the AI model may formulate a detailed travel itinerary. This may include suggested flight options, hotel bookings, car rental services, recommended places to visit, eat, and shop, estimated costs, times, and other logistical details. The itinerary might also feature alternative options and additional recommendations, allowing users to customize their plans further. The generated travel itinerary is then presented to the user through an intuitive and user-friendly interface within a software application. This interface allows users to review, modify, confirm, or reject the proposed itinerary. They can adjust, request alternatives, and finalize their plans, all within the application. The application may also implement a feedback loop, where users can rate and review their experiences, allowing the AI model to learn and improve its recommendations over time. Additionally, the instant solution can analyze user behavior and preferences over time to offer more personalized and relevant suggestions. In one embodiment, the instant solution may feature real-time updates and adjustments based on the availability of services, price fluctuations, and user modifications, ensuring that the user gets the most accurate and up-to-date information.

FIG. 5A illustrates a process 500 of ingesting data from a plurality of websites 534, 544, and 554 hosted by a plurality of web servers 530, 540, and 550, respectively, and training an AI model 522 based on the ingested data. In this example, a host platform 520 hosts a software application 521 that can query the plurality of web servers 530, 540, and 550 via a plurality of APIs 532, 542, and 552 of the plurality of web servers 530, 540, and 550, to retrieve web pages, documents, logs, files, and the like, which are associated with the plurality of websites 534, 544, and 554. The ingested data may include available flight data (e.g., real-time) ingested from airline websites, accommodation availability ingested from hotel and other websites, travel recommendations recommended from travel sites, and the like.

According to various embodiments, the ingested data from the plurality of websites 534, 544, and 554 may be input into the AI model 522 which is running on the host platform 520. Here, the software application 521 may convert the ingested data into vector format or other format prior to inputting the data into the AI model 522 thereby enabling the AI model 522 to be able to process the data. The AI model 522 may receive the input data and learn patterns, spatial arrangements, styles, colors, and the like of travel documents such as airplane tickets, hotel reservations, bus tickets, train tickets, rental car reservations, activity reservations, and the like. The learning process may also include learning preferences of users based on browsing history, transaction history, and the like. The trained AI model may be stored within a model repository 523 of the host platform 520.

FIG. 5B illustrates a process 501 of generating a travel itinerary for a user based on communication performed between a user of a user device 510 that is connected to the host platform 520 via a network and the software application 521 hosted on the host platform 520. Here, the user device 510 may include a user interface 512 where a user can input information about their travel preferences through input fields (not shown) and other input means on the user interface 512. The input information may include context about the user's upcoming trip such as a geographical location(s), lodging preferences, travel preferences, travel dates, travel locations, desired activities to perform, and the like. The context plus the travel timeline may be input to the AI model 522 by the software application 521.

According to various embodiments, the AI model 522 may generate a travel itinerary based on the inputs received from the user device 510 and the training that is performed in the example of FIG. 5A. Here, the AI model 522 may generate new content that includes travel dates, recommended flight information, recommended accommodations, recommended events, recommended costs, and the like. In this example, the AI model 522 may also retrieve user profile data from a user profile stored within a data store 524 of the host platform. Here, the user profile may include a user account such as a financial account, a social media account, an investment account, and the like. The user profile data may provide preferences that can be used by the AI model 522 to generate the travel itinerary. For example, the user profile data may include spending behavior, spending behavior on a trip, spending preferences, and the like.

FIG. 5C illustrates an example of a travel itinerary 560 that may be generated by the AI model 522 in FIG. 5B. In this example, the travel itinerary 560 may include client information 561 including a name of the client, contact information, travel dates, and the like. In some embodiments, the travel itinerary may also include one or more images 562 such as images of the destination where the user is travelling, images of events that are recommended, images of wildlife at the destination, and the like. The travel itinerary may be generated as a document such as a digital document (e.g., JavaScript object notation (JSON), extensible markup language (XML), portable document format (PDF), text, etc.) As another example, the travel itinerary may include a web page, an email, a message, and the like.

In addition to the client information 561 and the one or more images 562, the travel itinerary 560 may also include additional travel arrangements recommended by the AI model 522 in FIG. 5B, including flight information 563, accommodation information 564 such as suggested hotel stays, activity information 565 including recommended activities for the user while on their trip, and the like.

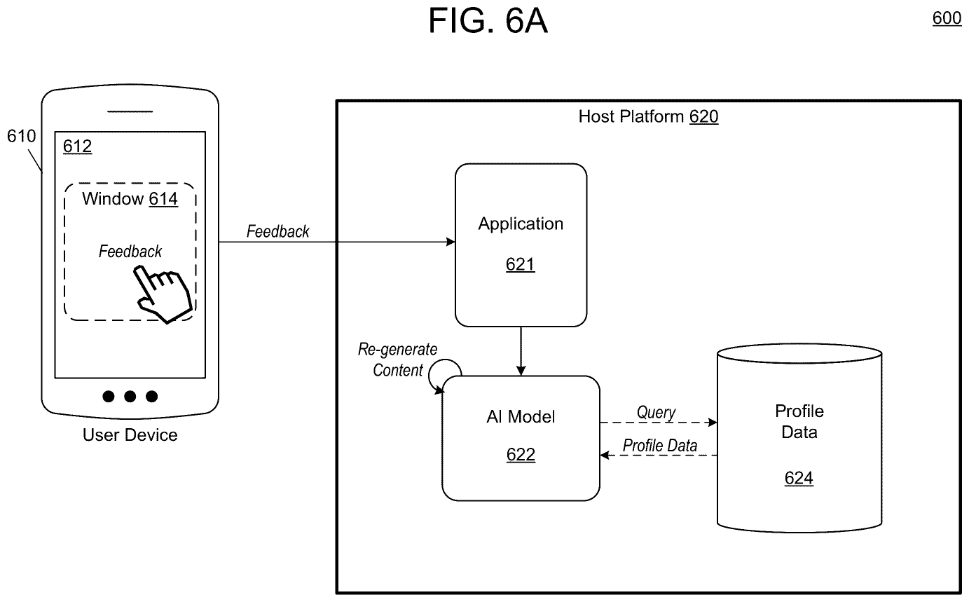

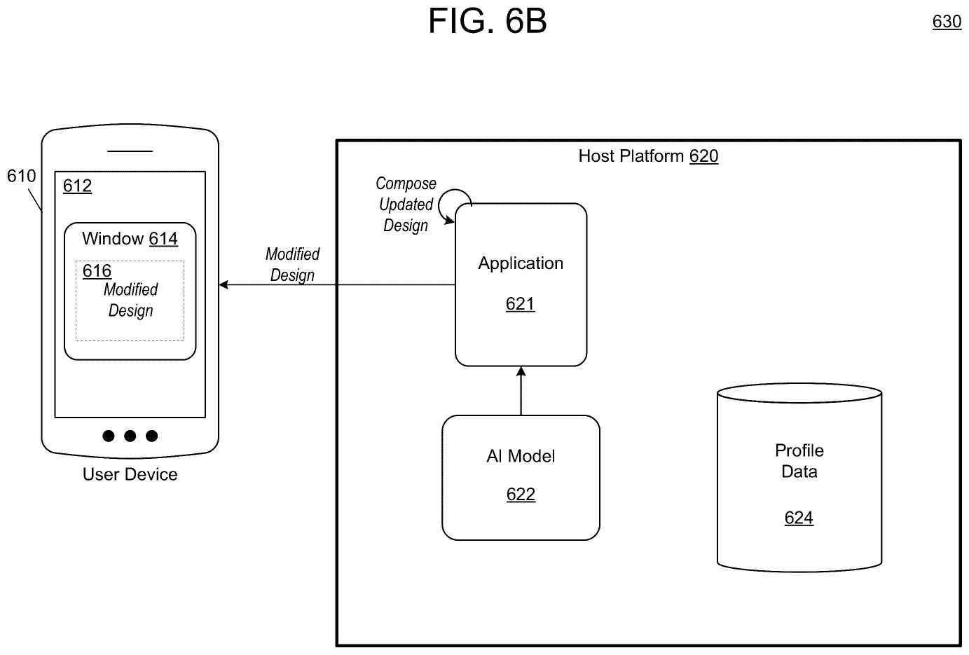

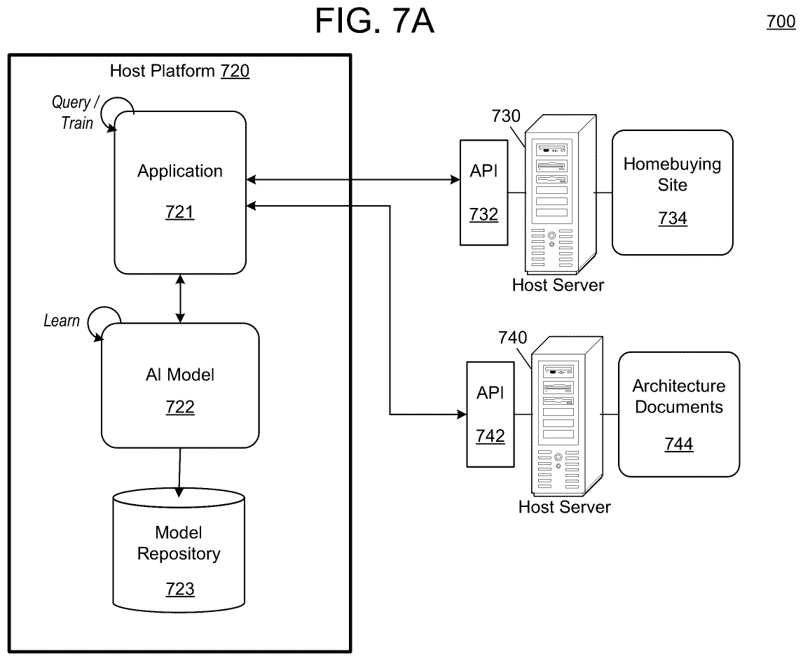

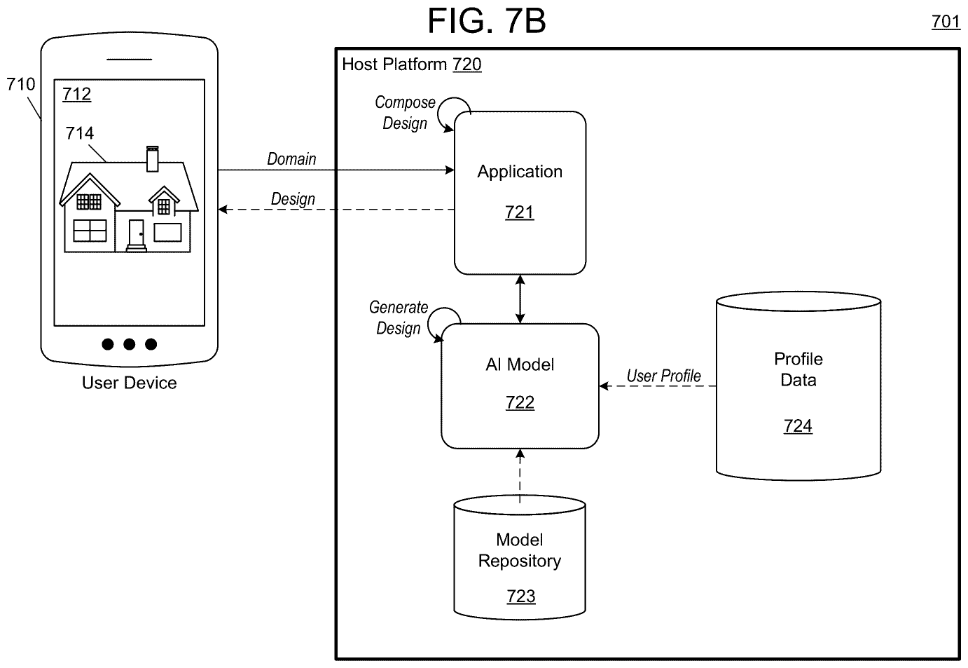

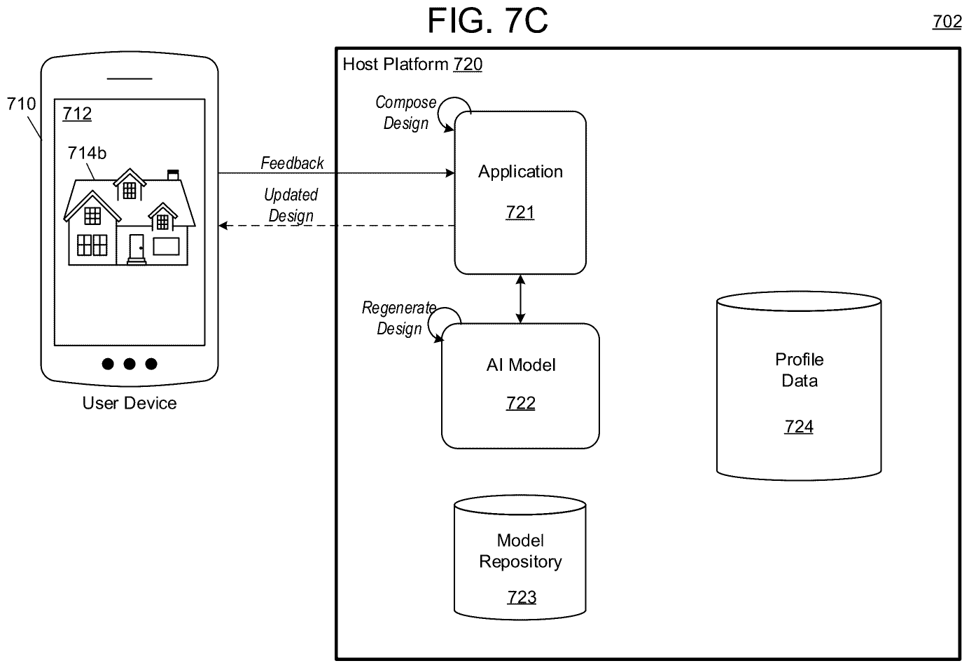

FIGS. 6A-6B illustrates a feedback process for retraining an AI model according to example embodiments. The feedback process may be performed with any of the example embodiments described herein including the examples shown and described with respect to FIGS. 7A-7C, FIGS. 8A-8B, and FIGS. 9A-9D. For example, FIG. 6A illustrates a process 600 of receiving feedback from a user device 610 based on custom content output by an AI model 622. As an example, the feedback may be in response to a custom travel itinerary, a custom image of a desired purchase such as a dream home, a numerical goal associated with the user, a description of a goal, and the like.

Referring to FIG. 6A, the user may input commands into a user interface 612 of the user device 610 to provide feedback via a window 614 of the user interface 612. The feedback may include the custom generated content and an indication of whether the recommended content is approved or if the user may prefer changes or modifications to be made to the content. Any suggested changes may be input as text on the user interface 612 and transferred to the software application 621 on the host platform 620. In response, the software application 621 may input the feedback to the AI model 622 which may execute on the feedback, the original input data, user profile data, etc., to generate a modified design as shown in the example of FIG. 6B. In addition, the AI model 622 may also receive profile data from a profile data store 624 of the host platform 620. The profile data may include account data of the user such as transaction history of a financial account, posted content from a social media account, and the like.

FIG. 6B illustrates a process 630 of generating a modified design 616 based on the feedback received by the AI model 622 in FIG. 6A. In this example, the AI model 622 may receive the original design, such as an original travel itinerary or original building design, and generate an update to the original travel itinerary or the original building design. For example, flight information, travel information, accommodations, travel times, travel locations, events to perform, etc. may be modified by the AI model 622 and used to replace the original design on the user interface 612.

FIGS. 7A-7C illustrates a process of generating a design of a structure according to example embodiments. The term “structure” is not meant to be a limiting term and should not be construed as limiting the design to any particular structural component. As an example, the structure may be a house, a building, an office, a part of a building, a home improvement, a garage, a shed, and the like. The structure may be a physical structure that is modeled through the design process described herein. The model may include a diagram, an image, text content, a three-dimensional image, a video, a plurality of images (e.g., thumbnails, etc.), and the like.

The AI model described herein may also generate other types of content besides travel itineraries. For example, the AI model may be trained on ingested website data gathered through APIs, along with user prompts and their responses, to generate a building design. The generated design is then displayed on a user interface within a software application. The first step in this process is the ingesting of inspirational data from various websites and images found on the internet. The instant solution may utilize APIs to pull relevant data and images from various websites, expanding the pool of inspirations. Next, the AI model is trained on the ingested data to understand various design elements, architectural styles, materials, color schemes, and spatial arrangements.

The AI model learns to recognize and replicate design patterns, combining elements in novel ways to generate unique designs. Users can interact with the instant solution, specifying their preferences, requirements, and any specific design elements they want. They can also provide responses to prompts, refining their design preferences and requirements. Leveraging the trained AI model and user input, the instant solution dynamically generates a building design. It combines the elements from the user's inspirations with other learned design patterns to create a design that aligns with the user's vision and preferences. The generated design is rendered and displayed through a user interface. This concept allows users without architectural or design knowledge to create sophisticated and coherent designs. Users can see their inspirations translated into tangible designs, enhancing their engagement in the design process.

For example, FIG. 7A illustrates a process 700 of ingesting data from a plurality of websites 734 and 744 hosted by a plurality of web servers 730 and 740, respectively, and training an AI model 722 based on the ingested data. In this example, a host platform 720 hosts a software application 721 that can query the plurality of web servers 730 and 740 via a plurality of APIs 732 and 742 of the plurality of web servers 730 and 740, respectively, to retrieve web pages, documents, logs, files, and the like, which are associated with the plurality of websites 734 and 744. The ingested data may include homes that are currently for sale, home designs of existing homes, structural designs, cost data, materials data, and the like, which can be used to generate a custom-designed structure.

According to various embodiments, the ingested data from the plurality of websites 734 and 744 may be input into the AI model 722 which is running on the host platform 720. Here, the software application 721 may convert the ingested data into vector format or other format prior to inputting the data into the AI model 722 thereby enabling the AI model 722 to be able to process the data. The AI model 722 may receive the input data and learn patterns, spatial arrangements, styles, colors, and the like of structural designs including architectural patterns, interior design patterns, exterior design patterns, bathroom design patterns, and the like. The learning process may also include learning preferences of users such as based on browsing history, transaction history, and the like. The trained AI model may be stored within a model repository 723 of the host platform 720. The trained AI model may be able to generate a model of a home or other structure based on input data from a user.

FIG. 7B illustrates a process 701 of generating a custom structural design 714 for a user based on communication performed between a user of a user device 710 and the software application 721 hosted on the host platform 720. Here, the user device 710 may include a user interface 712 where a user can input information about their design that provides a domain for the AI model 722 to use to generate the design. The input information from the user may include preferences such as number of rooms, number of bedrooms, number of bathrooms, square footage sizes, yard size, home features, yard features, and the like, through input fields (not shown) and other input means on the user interface 712. The input information may provide details that the AI model 722 can use to generate the structural design for the user, and the like. The information from the user may be input by the software application 721 to the AI model 722.

According to various embodiments, the AI model 722 may generate the custom structural design 714 such as a blueprint, an image, a photo, a document, and/or the like, which includes images and/or text that provides information about the structure. The custom structural design 714 may include content generated by the AI model 722 and formatted by the software application 721. The custom structural design 714 may be output by the software application 721 on the user interface 712 of the user device 710.

In this example, the AI model 722 may generate one or more images of an interior of the structure, one or more images of an exterior of the structure, and the like. The AI model 722 may generate new design content that includes square footage sizes, room sizes, doorway locations, blueprints, bathrooms, and the like. In some embodiments, the AI model 722 may also retrieve user profile data from a user profile stored within a data store 724 of the host platform 720. Here, the user profile may include a user account such as a financial account, a social media account, an investment account, and the like. The user profile data may provide preferences that can be used by the AI model 722 to generate the structural design. For example, the user profile data may include spending behavior, spending behavior on home related items, spending preferences, and the like.

FIG. 7C illustrates a process 702 of modifying the custom structural design 714 based on user feedback to generate an updated custom design 714b. Referring to FIG. 7C, the software application 721 may output one or more queries on the user interface 712 with the custom structural design 714, shown in FIG. 7B. The queries may include queries about changes to be made to the design that the user may not have provided initially such as changes to room sizes, number of rooms, number of windows, location of rooms, yard features, and the like. Here, the queries may be generated by the AI model 722 through feature engineering. As another example, the queries may be programmed within the software application 721.

In this example, the feedback received from the user interface 712 is transferred to the AI model 722 via the software application 721. In response, the AI model 722 executes on the feedback, the custom structural design 714 from FIG. 7B, profile data, and the like, and determines a modification to the custom structural design 714. The software application 721 then generates an updated custom design 714b based on the modification determined by the AI model 722 and displays the updated custom design 714b on the user interface 712.

According to various embodiments, the AI model described herein may also be used to generate goals that are text-based rather than or in addition to images. Goal setting can be difficult for individuals that do not have a sufficient understanding of how to set the goal. It can be helpful to review life accomplishments to understand better how to move forward. A resume or profile on professional networking websites, understanding a financial history, and other personal information from social websites can help in understanding a person's path and uncovering new goals. This instant solution uses an AI model trained on profile data to determine a goal for a user. The executed AI model leverages the profile data along with prompts and user responses to generate a goal and display it through a user interface.

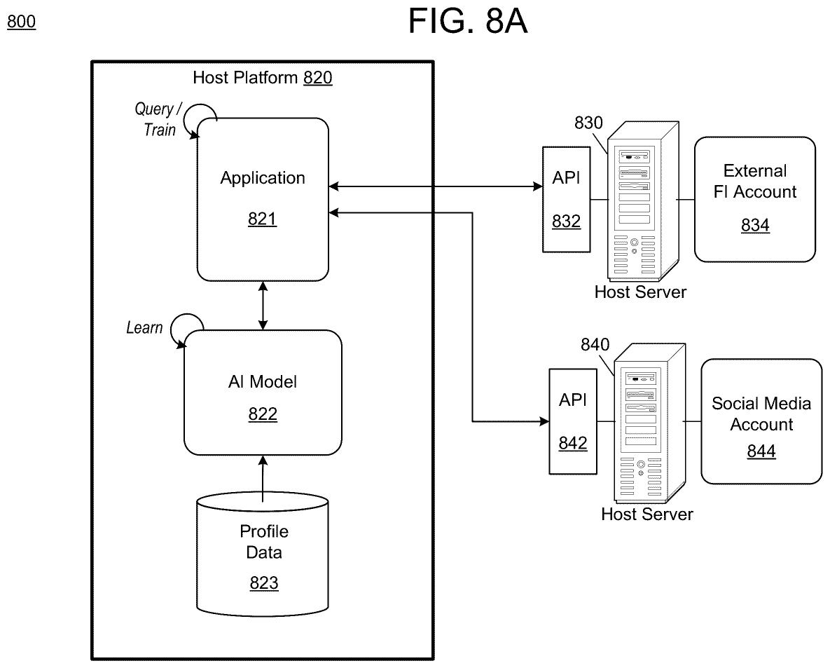

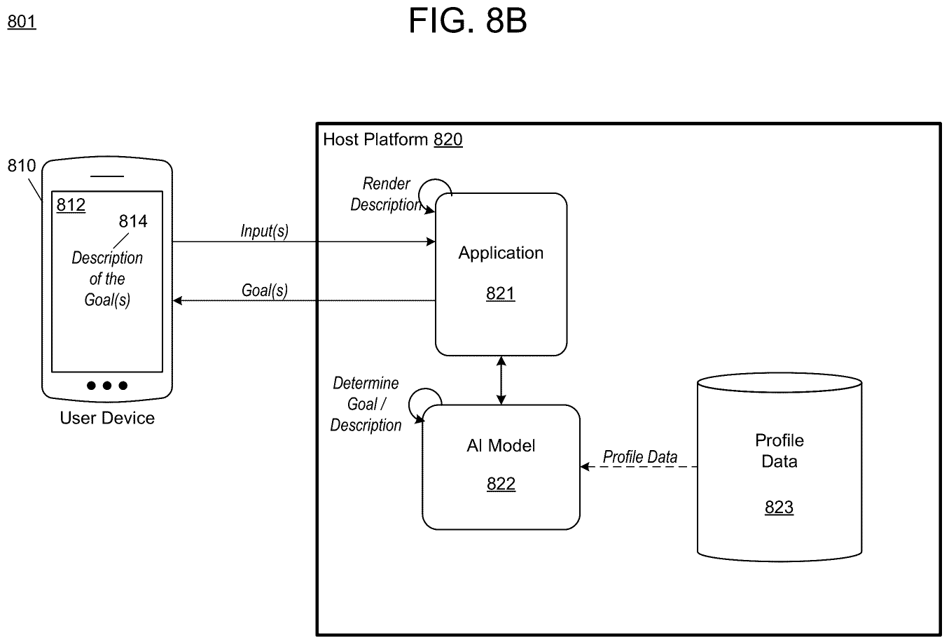

FIGS. 8A-8B illustrate a process of generating a description of a goal according to example embodiments. According to various embodiments, software described herein may ingest data from both local sources and external sources. Here, the host platform may connect to external data sources such as social media accounts, financial accounts, career building accounts, professional accounts, and the like, and ingest data of the user to provide a customized goal that is specific to the user based on attributes such as the user's age, the user's family, the user's current place in their career, the user's current place in their life, and the like.

For example, FIG. 8A illustrates a process 800 of ingesting data from a plurality of websites 834 and 844 hosted by a plurality of web servers 830 and 840, respectively, and training an AI model 822 based on the ingested data. In this example, a host platform 820 hosts a software application 821 that can query the plurality of web servers 830 and 840 via a plurality of APIs 832 and 842 of the plurality of web servers 830 and 840, respectively, to retrieve web pages, documents, logs, files, and the like, which are associated with the plurality of websites 834 and 844. The ingested data may include social media data, resume data, financial data, transaction history data, investment account data, and the like.

According to various embodiments, the user may register credentials for logging into their external accounts (e.g., social media, financial, investment, etc.) As such, the software application 821 may establish secure communication channels with the external sources to retrieve sensitive user data safely and securely. The secure channel may be established by the software application 821 transmitting the user credentials previously registered with the software application 821 to the external source to prove the identity of the user.

According to various embodiments, the ingested data from the plurality of websites 834 and 844 may be input into the AI model 822 which is running on the host platform 820. Here, the software application 821 may convert the ingested data into vector format or other format prior to inputting the data into the AI model 822 thereby enabling the AI model 822 to be able to process the data. The AI model 822 may receive the input data and learn goals and other interests of the user such as financial goals, personal goals, family goals, and the like, Goals may include saving for a home, saving for a child's education, purchasing a new car, saving for retirement, and the like. The learning process may also include learning goal preferences of users such as based on browsing history, transaction history, and the like, which may be obtained from a profile data store 823 of the host platform 820.

FIG. 8B illustrates a process 801 of generating a description of a goal 814 for a user based on communication performed between a user of a user device 810 and the software application 821 hosted on the host platform 820. Here, the user device 810 may include a user interface 812 where a user can input information about their goal that provides a domain for the AI model 822 to generate the description of the goal. The input information from the user may include preferences such as purchase items of interest, saving preferences and reasons, upcoming home improvements, and the like. The input information may provide details that the AI model 822 can use to generate the description of the goal 814 (i.e., a text-based description) for the user, and the like. The information from the user may be input by the software application 821 to the AI model 822.

As an example, a description of a goal may include a description of a savings plan for the user to perform to save money for a new home. According to various embodiments, the AI model may generate a text-based description of the steps that the user should perform each month including an amount that should be saved, a source of the amount, a period of time when such amount should be taken out, and the like. The text-based description may be output by the AI model 822 to the software application 821 which formats the text-based description and transfers it to the user interface 812 of the user device 810. In some embodiments, the goal, the source, the amount, and the like, may be identified based on profile data of the user which is obtained from the profile data store 823 and input to the AI model 822.

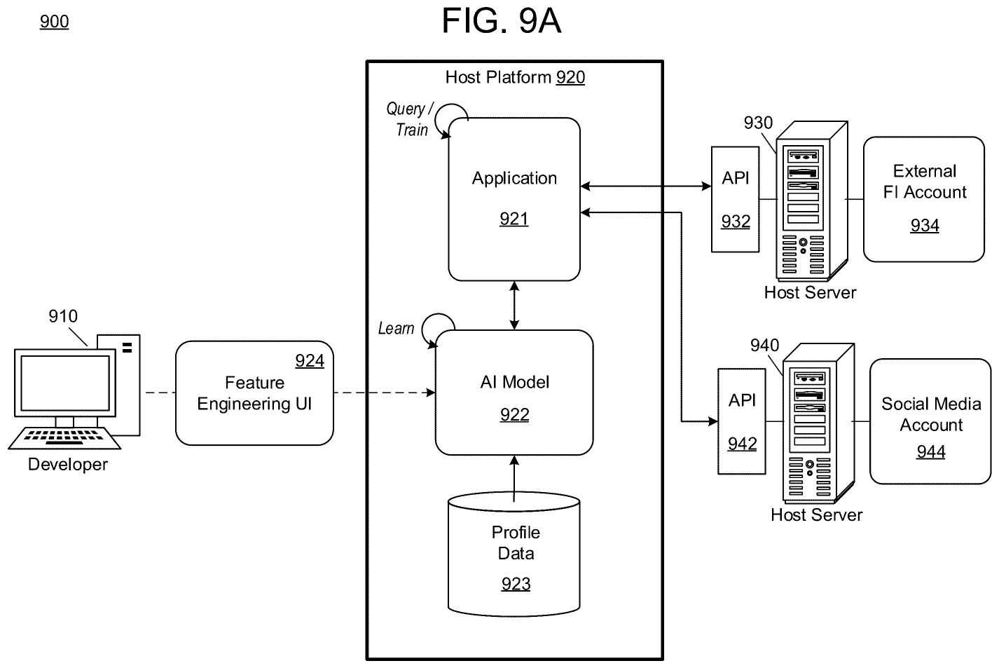

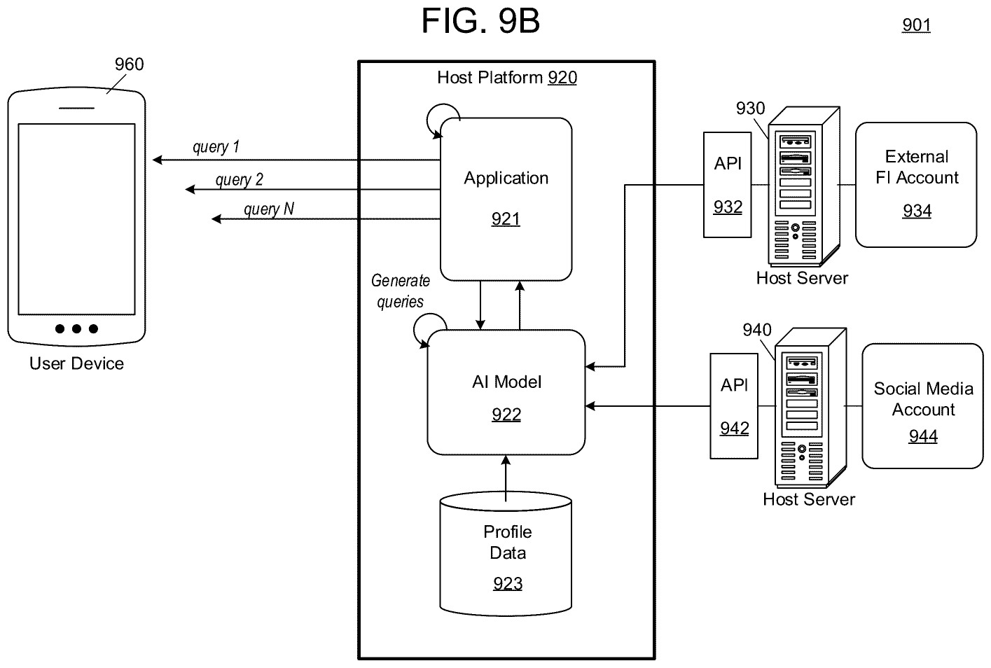

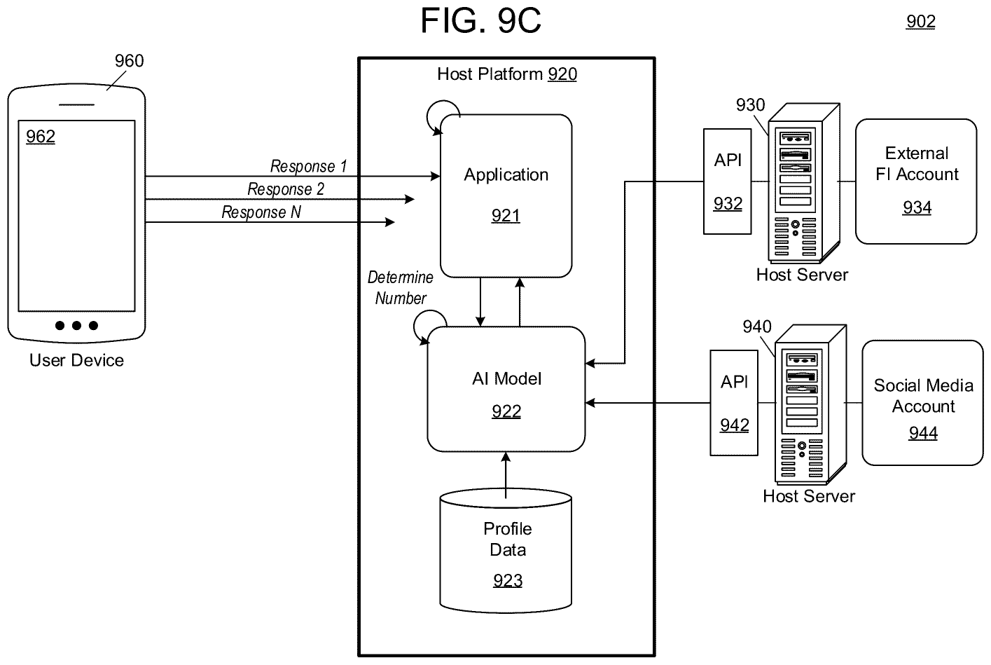

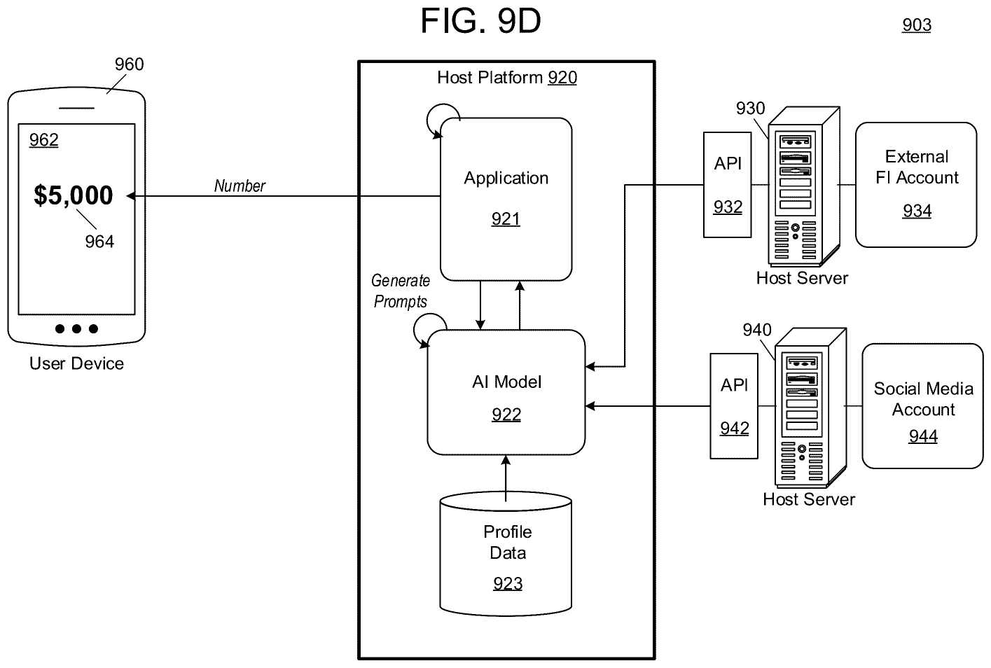

FIGS. 9A-9D illustrate a process of generating a numerical goal for a user according to example embodiments. Creating financial goals is a way to save money for a car, a house, home appliances, vacations, college expenses, loans, or retirement. Regardless of the size of the goal, the steps to achieve the goal are the same. The user must determine the amount to save for the goal, a target deadline by which they plan to reach the goal, and how much to apply towards that goal and how often. Many goal-planning tools and websites ask a user to enter the number for their goal but offer little or no help on how to find or determine that number. In the examples described below, an AI model can determine a numerical value based on contextual data input to the AI model in association with a user.

For example, the software application may collect and analyze historical financial data about the user, such as income, expenses, savings, and previous financial goals. An AI model is trained by processing this historical data to identify patterns, behaviors, and constraints that will influence the generation of the numerical goal. Additionally, the user submits a request to the instant solution to set the context for the goal. The AI model generates a realistic and achievable numerical goal based on the user's request and historical data, determining an optimal amount and timeline. The generated numerical goal is displayed on the user interface, along with pertinent details like recommended contributions and a timeline to achieve it. The instant solution may track the user's progress towards the goal, providing regular updates, reminders, and adjustments based on any changes in the user's financial situation. The AI model continuously learns from user interactions and feedback, refining its goal-generation capabilities for future interactions. The instant solution may suggest new goals or modifications to existing ones based on the user's current financial status and past achievements.

FIG. 9A illustrates a process 900 of ingesting data from a plurality of websites 934 and 944 hosted by a plurality of web servers 930 and 940, respectively, and training an AI model 922 based on the ingested data. In this example, a host platform 920 hosts a software application 921 that can query the plurality of web servers 930 and 940 via a plurality of APIs 932 and 942 of the plurality of web servers 930 and 940 to retrieve web pages, documents, logs, files, and the like, which are associated with the plurality of websites 934 and 944. The ingested data may include social media content, financial history content, life history content, family information, and the like. In addition, the software application 921 may query local data such as a profile data store 923 for user profile data of the user held by the host platform 920.

According to various embodiments, the ingested data from the plurality of websites 934 and 944 and the profile data store 923 may be input into the AI model 922 which is running on the host platform 920. Here, the software application 921 may convert the ingested data into vector format or other format prior to inputting the data into the AI model 922 thereby enabling the AI model 922 to be able to process the data. The AI model 922 may receive the input data and learn numerical values of purchases made by the user, and how long it took the user to save for those purchases. The AI model 922 may learn spending habits, saving habits, income habits, and the like of the user thereby enabling the AI model 922 to make accurate predictions about how much money (i.e., a numerical value) to save for an upcoming goal such as a purchase, an educational requirement, a home improvement, or the like.

In addition, a feature engineering process may be performed by a developer via a developer device 910. Here, the developer may use a user interface 924 to configure queries submitted by the software application and/or the AI model 922 to a user to help identify the goal in as few queries as possible.

FIG. 9B illustrates a process 901 of querying a user for additional information about the goal in accordance with example embodiments. Referring to FIG. 9B, the software application 921 may issue a plurality of queries to a user via a user device 960 of the user. In particular, the queries may include text-based questions that are displayed on a user interface of the user device 960. The queries may ask for additional information such as timelines, costs, family information, employment information, goal information, and the like.

The user may also submit responses to the queries as shown in FIG. 9C. For example, FIG. 9C illustrates a process 902 of determining a numerical value associated with a goal of a user based on responses to the queries. In this example, the user may input responses to the queries in the form of text on the user interface 962 of the user device 960 and submit the responses to the software application 921. The software application 921 may combine the responses received from the user device 960 with the queries sent to the user device 960 to generate “prompts” that are submitted to the AI model 922. In response, the AI model 922 may generate a numerical value 964, shown in FIG. 9D, associated with the goal of the user. The numerical value 964 may represent a savings goal. As another example, the numerical value may be a range of values. During this time, the software application 921 may add a delay between the data transmissions to the AI model 922 to enable the AI model 922 to fully process the previous data.

In some embodiments, the AI model 922 may also output a start date, an end date, a suggested source of the numerical value (e.g., money, etc.), and the like. Furthermore, as shown in process 903 of FIG. 9D, the numerical value 964 may be output on the user interface 962 of the user device 960 by the software application 921 on the host platform 920.

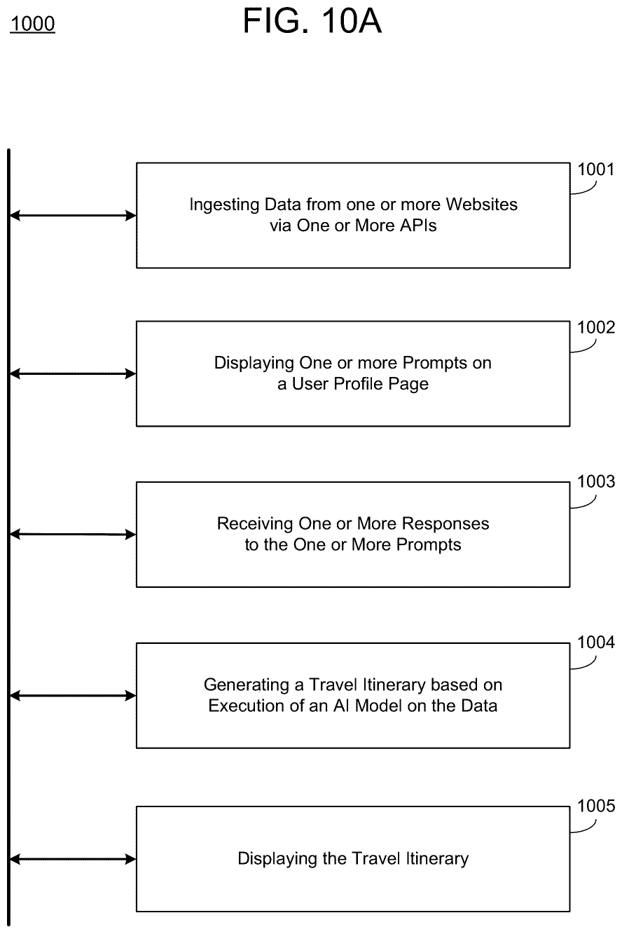

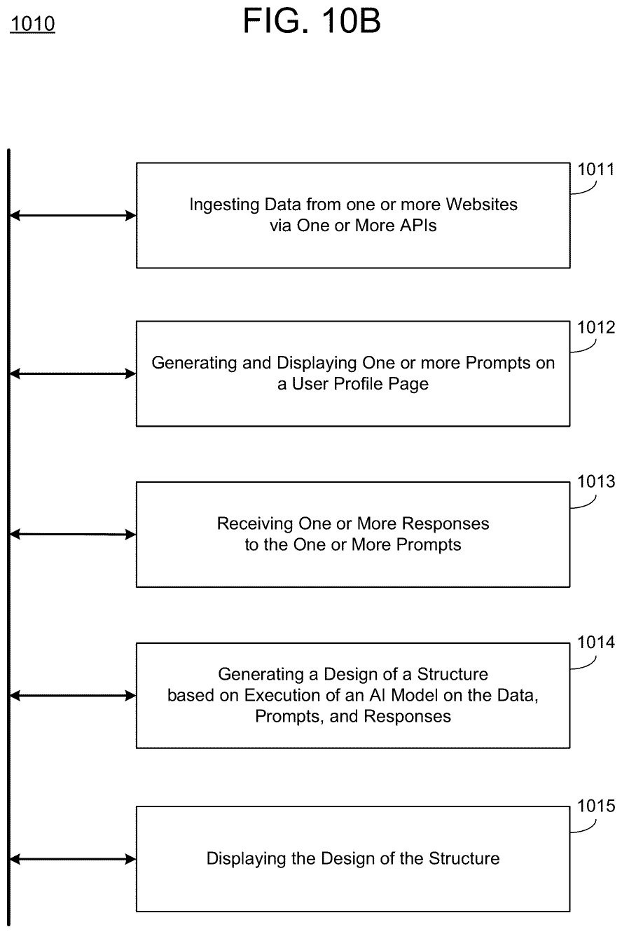

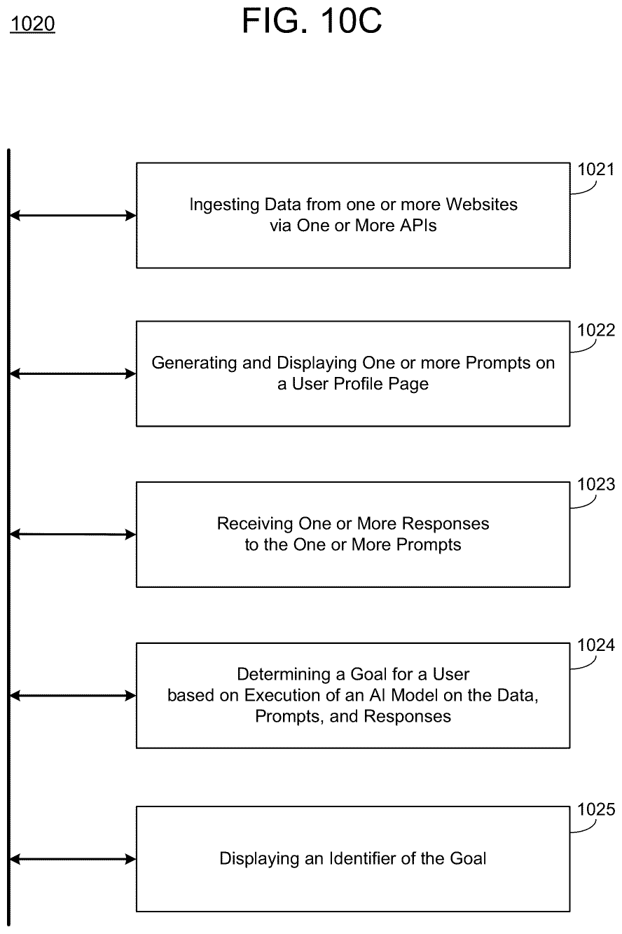

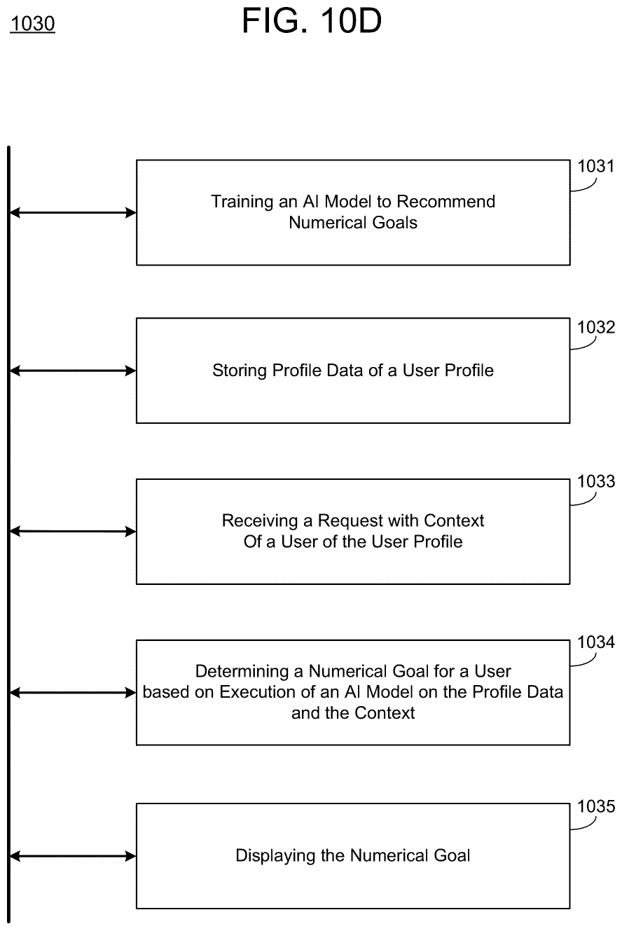

FIG. 10A illustrates a method 1000 of generating a travel itinerary through artificial intelligence according to example embodiments. For example, the method 1000 may be performed by a host platform such as a web server, cloud platform, on-premises server, or the like. Referring to FIG. 10A, in 1001, the method may include ingesting data from one or more websites via one or more APIs and storing the data within a data store of a host platform. The data may include profile data, account data, user data, and the like.

In 1002, the method may include displaying one or more prompts on a user interface of a user profile page within a software application hosted by the host platform. In 1003, the method may include receiving one or more responses to the one or more prompts. In 1004, the method may include generating a travel itinerary based on execution of an AI model on the ingested data from the one or more websites, the one or more prompts, and the one or more responses. In 1005, the method may include displaying the travel itinerary via the user interface of the user profile page of the software application.

In some embodiments, the generating may include generating a digital document that includes a suggested travel date, a suggested travel destination, and a suggested mode of transportation, wherein the digital document includes image content which is output by the AI model. In some embodiments, the generating may further include generating the one or more prompts based on execution of the AI model on the ingested data from the one or more websites and a user profile of the user stored within the data store of the host platform.

In some embodiments, the method may further include ingesting additional data from the one or more websites via the one or more APIs, generating a change to the travel itinerary based on execution of the AI model on the additional data, and displaying the change to the travel itinerary via the user interface of the user profile page of the software application. In some embodiments, the method may further include ingesting preference data from a user profile corresponding to the user profile page, and the generating further comprises generating the travel itinerary based on execution of the AI model on the preference data from the user profile.

In some embodiments, the method may further include receiving feedback about the travel itinerary from the user interface of the user profile page of the software application and modifying one or more attributes within the travel itinerary based on the feedback from the user interface. In some embodiments, the method further comprises receiving feedback about the travel itinerary from the user interface of the user profile page of the software application and executing the AI model on the feedback and the travel itinerary to retrain the AI model. In some embodiments, the method may further include determining a travel destination, generating an image of the travel destination based on execution of the AI model on the ingested data from the one or more websites, the one or more prompts, and the one or more responses, and storing the image within the travel itinerary.

FIG. 10B illustrates a method 1010 of generating a structural design through artificial intelligence according to example embodiments. For example, the method 1010 may be performed by a host platform such as a web server, cloud platform, on-premises server, or the like. Referring to FIG. 10B, in 1011, the method may include ingesting data from one or more websites via one or more APIs and storing the data within a data store of a host platform.

In 1012, the method may include generating one or more prompts and displaying the one or more prompts on a user interface of a user profile page within a software application hosted by the host platform. In 1013, the method may include receiving one or more responses to the one or more prompts. In 1014, the method may include generating a design of a structure based on execution of an AI model on the ingested data from the one or more websites, the one or more prompts, and the one or more responses. In 1015, the method may include displaying the design of the structure via the user interface of the user profile page of the software application.

In some embodiments, the generating may include generating an image of the structure based on execution of the AI model on a plurality of images of different structures which are ingested from one or more websites via the one or more APIs. In some embodiments, the method may further include receiving feedback about the design from the user interface, generating one or more additional prompts based on execution of the AI model on the feedback, and displaying the one or more additional prompts on the user interface. In some embodiments, the method may further include receiving one or more responses to the one or more additional prompts via the user interface, and in response, modifying the design of the structure on the user interface based on the one or more responses to generate a modified design.

In some embodiments, the generating may further include generating images of an interior of the structure based on execution of the AI model on images of interiors of other structures which are ingested from the one or more websites and displaying the images of the interior as thumbnails within the user profile page of the software application. In some embodiments, the generating may further include generating images of an exterior of the structure based on execution of the AI model on images of exteriors of other structures which are ingested from the one or more websites, and displaying the images of the exterior as thumbnails within the user profile page of the software application.

In some embodiments, the method may further include training the AI model based on historical images of other structures, wherein the training comprises training the AI model to understand spatial arrangements, colors, and architectural styles of the other structures. In some embodiments, the method may further include simulating a view of the design of the structure within a three-dimensional space on the user interface and moving a field of view of the view in three-dimensions based on commands received via the user interface.

FIG. 10C illustrates a method 1020 of generating a description of a goal according to example embodiments. For example, the method 1020 may be performed by a host platform such as a web server, cloud platform, on-premises server, or the like. Referring to FIG. 10C, in 1021, the method may include ingesting profile data from one or more websites via one or more APIs and storing the profile data within a data store. In 1022, the method may include generating and displaying one or more prompts on a user interface of a user profile page within a software application hosted by a host platform.

In 1023, the method may include receiving one or more responses to the one or more prompts. In 1024, the method may include determining a goal for a user of the user profile page based on execution of an AI model on the profile data, the one or more prompts, and the one or more responses to the one or more prompts. In 1025, the method may include displaying an identifier of the goal via the user interface of the user profile page of the software application.

In some embodiments, the method may further include registering credentials of a user profile hosted by an external system within the software application, establishing a secure communication channel between the host platform and the external system based on the credentials, and the profile data from the user profile hosted by the external system via the secure communication channel. In some embodiments, the determining may include generating a text-based description of the goal based on execution of the AI model on the profile data, the one or more prompts, and the one or more responses to the one or more prompts, and displaying the text-based description of the goal within the user interface.

In some embodiments, the method may further include training the AI model to identify goals and describe the goals based on execution of the AI model on historical accomplishments of a plurality of users and the profile data of the plurality of users. In some embodiments, the method may further include ingesting a user profile of a user from a data store, determining an upcoming life milestone of the user based on execution of the AI model on the user profile of the user, and displaying the upcoming life milestone via the user interface.

In some embodiments, the method may further include receiving feedback about the goal via the user interface, modifying the goal based on execution of the AI model on the feedback to generate a modified goal, and replacing the goal displayed on the user interface with the modified goal. In some embodiments, the ingesting profile data from a plurality of user profiles may include ingesting profile data from at least one locally hosted user profile and at least one externally hosted user profile, and aggregating the profile data from the plurality of user profiles prior to inputting the profile data to the AI model.

FIG. 10D illustrates a method 1030 of generating a numerical goal according to example embodiments. For example, the method 1030 may be performed by a host platform such as a web server, cloud platform, on-premises server, or the like. Referring to FIG. 10D, in 1031, the method may include training an AI model to recommend numerical goals based on execution of the AI model on historical profile data and contextual data that is associated with the historical profile data. In some embodiments, the AI model may be a generative AI model, or the like.

In 1032, the method may include storing profile data of a user profile within a data store of a software application. In 1033, the method may include receiving a request via a user interface of a user profile page of the software application, wherein the request comprises context of a user of the user profile. In 1034, the method may include determining a numerical goal for the user profile based on execution of the AI model on the profile data of the user profile and the context. In 1035, the method may include displaying the numerical goal via the user interface of the user profile page within the software application.

In some embodiments, the method may further include generating one or more prompts based on the profile data of the user profile and the context, displaying the one or more prompts via the user interface, and receiving one or more responses to the prompts via the user interface. In some embodiments, the determining may further include determining the numerical goal for the user profile based on execution of the AI model on the one or more prompts and the one or more responses to the one or more prompts received via the user interface. In some embodiments, the determining may further include determining a timeline for obtaining the numerical goal based on execution of the AI model on the profile data of the user profile and the context and displaying the timeline with the numerical goal on the user interface.

In some embodiments, the method may further include monitoring activity of the user profile within the data store of the software application over a period of time, determining a modification to the numerical goal based on execution of the AI model on the monitored activity of the user profile, and displaying the modification to the numerical goal via the user interface. In some embodiments, the method may further include identifying a plurality of user profiles that can be a source of the numerical goal, selecting a user profile from the plurality of user profiles based on execution of the AI model on the profile data of the user profile and the context, and displaying an identifier of the user profile selected from the plurality of user profiles via the user interface. In some embodiments, the determining the numerical goal may include determining an item of purchase based on execution of the AI model on the context, and determining the numerical goal based on execution of the AI model on the item of purchase and cost data of the item ingested from one or more external websites.

The instant solution involves a software application integrating AI to facilitate personalized financial goal-setting and travel itinerary planning. Users input their financial details and consent to data retrieval from external sources, enabling the AI model to generate initial financial goals based on the user's current financial situation. These goals are presented for user review and adjustment, with real-time updates and recommendations to ensure adaptability. Similarly, users provide preferences and receive AI-generated itineraries incorporating real-time travel data for travel planning. Users can adjust these travel plans and provide feedback, resulting in refined recommendations. The instant solution continuously ingests external data, engages users with context-specific prompts, and utilizes feedback loops to enhance the user experience.

In one embodiment, the software application generates goals based on user profile data and integrates real-time financial information from the user's bank accounts and investments through APIs. The AI model considers the user's current financial situation and market trends to recommend updated and realistic financial goals, such as retirement savings, investing in specific stocks, or paying off debt. A user profile initialization message originates from the user and is received by the software application. This message marks the beginning of the goal-setting process as users create or update their profiles within the software application. This includes sharing essential personal financial details such as income, expenses, savings, and existing financial goals. The software application initiates an external financial data integration message and directs it toward external financial data sources, invoking APIs such as bank APIs or investment APIs. This message occurs with the user's consent and involves the software application sending requests to external sources to retrieve the user's up-to-date financial information. This encompasses account balances, investment portfolios, and transaction history.

After gathering the user's financial data, the software application sends a user goal generation request message to the AI model. It furnishes the AI model with the user's profile data and the acquired external financial information, thereby requesting the initial generation of financial goals based on the user's current financial situation. The AI model generates financial goals and initiates the AI model goal recommendation message. In this message, the AI model processes the user data and external financial information, using this data to generate a set of recommended financial goals. These recommendations encompass saving targets, investment strategies, and debt repayment plans. These goal recommendations are then conveyed back to the software application. The software application sends a message to a device associated with the user for reviewing and adjusting the user goal. This message involves the presentation of the AI-generated financial goals through the software application's user interface. Users are provided with the opportunity to review, modify, or accept these goals, considering their personal preferences and financial aspirations. This message serves to capture the user's feedback and any adjustments made.

Subsequently, the software application sends an updated goal generation request to the AI model. This request message is triggered when the user adjusts the recommended goals. It includes the updated user goals and feedback to refine the financial goals based on the user's input. A message with the finalized goal is sent by the AI model and received by the software application. The AI model processes the user's adjusted goals and finalizes financial goals. These finalized goals are then presented to the user through the software application's user interface for confirmation and further planning. Goal tracking and progress monitoring is a continuous process where the software application, as the sender, communicates messages with the AI model, as the receiver. These messages relay the user's progress towards their financial goals and monitor financial transactions. It ensures that the goals remain achievable and can be adjusted, if necessary, based on real-time updates.

These messages facilitate a dynamic and interactive process where the user's financial goals are initially generated based on their financial data and recommendations from the AI model. Users can review, modify, and finalize these goals, creating a personalized and adaptive financial planning experience. The software application is the central hub orchestrating communication between the user, external financial data sources, and the AI model, ensuring a seamless goal-setting process.

In one embodiment, the software application continuously monitors external data sources for travel-related information, including flight prices, hotel availability, and local events. When users access their profile, the AI model provides real-time travel recommendations and itineraries based on current data, ensuring users get the best deals and experiences for their upcoming trips. The process begins with the user creating a new travel profile or updating an existing one within the software application. A message to collect user profile and preferences includes vital information, including travel destination preferences, travel dates, budget constraints, and any specific travel-related preferences the user may have. With the user's consent, the software application sends requests to external data sources. These requests are for retrieving pertinent travel-related information. This encompassing data may include details on flight availability, hotel options, local attractions, and weather forecasts. Building upon the user's travel preferences and the external data sources, the software application sends a request to the AI model. This request includes all the necessary inputs to create a personalized travel itinerary. This comprehensive itinerary may cover various aspects, including flight options, accommodation choices, and recommended activities.

The AI model, containing the user's travel profile, preferences, and external data, creates a travel itinerary. Factors like budget constraints, travel duration, and the user's specific interests are considered during this process. Once the itinerary is created, it is returned to the software application.

The software application presents the AI-generated travel itinerary to the user via the user interface. This is when the user can carefully review the itinerary, make any desired changes, or accept it. Additionally, a user feedback message provides a process for capturing user feedback and making adjustments.

The software application can accommodate when the user decides to modify the proposed itinerary or provide feedback. It sends an itinerary adjustment request message directed at the AI model, which includes the user's adjustments and preferences, all aimed at refining the travel itinerary. The AI model generates the finalized travel itinerary, incorporating the user's adjustments and preferences. This comprehensive itinerary includes confirmed flight bookings, hotel reservations, activity recommendations, and a detailed itinerary schedule. This final version is then presented to the user for their approval via the software application. Upon the user accepting the finalized itinerary, the software application sends booking requests to relevant travel booking services. These requests aim to secure flights, accommodations, and activities per the approved itinerary. The software application continuously monitors real-time travel-related information. This includes crucial updates on flight statuses and any unexpected weather changes. In response, the software application promptly sends notifications to the user, ensuring they remain well-informed and can adjust their travel plans.

An AI model is trained to propose numerical goals by analyzing historical profile data and contextual information in one embodiment. During training, the AI model learns from an extensive dataset, discerning patterns and relationships between profile attributes, context, and past user-set goals. Once the AI model is prepared, user profile data is stored in a software application's data store, serving as a repository for user-specific information, including past goals, preferences, demographics, and other pertinent data influencing goal recommendations. Users engage with the instant solution through the user interface, typically on their profile page, where they input preferences, aspirations, and contextual details such as vacation savings or a home down payment. Upon receiving a user's request, the AI model analyzes the user's profile data, considering historical data from similar users and the context provided to determine a numerical goal tailored to the user's profile and situation. For example, if a user is saving for a vacation, providing details like income, current savings, and travel preferences, the AI model calculates a recommended savings goal. Finally, the determined numerical goal is presented on the user's profile page via the user interface, ensuring accessibility and clarity for the user, with the interface rendering the information in a user-friendly format for ease of understanding and taking further actions.

In one embodiment, the implementation involves various components of the instant solution working together to provide users with personalized and realistic financial goals. Messages are exchanged between these components, with each message specifying the sending processor, the receiving processor, and message details. It starts with the user profile initialization message, where the user creates or updates their profile within the software application, including personal financial information. Then, the external financial data integration message involves the software application sending requests to external financial data sources to fetch the user's current financial data. Next, the user goal generation request message is sent from the software application to an AI model, providing the user's profile and external financial data to generate initial financial goals. The AI model goal recommendation message follows, where the AI model processes the data and generates recommended financial goals sent back to the software application. The user goal review and adjustment message allows users to review, modify, or accept these goals, capturing their feedback. The updated goal generation request message is triggered to refine the goals if the user adjusts their input. The finalized goal presentation message presents the AI-generated and user-refined financial goals for confirmation and planning. Lastly, the goal tracking and progress monitoring ensures continuous tracking and updates on goal progress, maintaining flexibility and adaptability in the financial planning experience, with the software application orchestrating communication between the user, external financial data sources, and the AI model.

In one embodiment, in addition to considering the user's initial request and context, the AI model incorporates the responses to the prompts into the goal-determination process. This allows for a more precise and personalized recommendation. For example, the user initially requested to save for a vacation and provided their income, but later, responded to a prompt with specific travel dates. In that case, the AI model can calculate a more accurate savings goal tailored to those dates. After the AI model has processed the user's request, context, and prompt responses, it calculates the numerical goal and a timeline for achieving it. For example, a user wants to save for a vacation and has provided information about their income, expenses, and travel dates. In that case, the AI model can estimate how long the user will take to reach their savings goal, factoring in their financial situation. The determined timeline for achieving the numerical goal is displayed alongside the goal on the user's profile page via the user interface. This timeline provides the user with a clear understanding of when they can expect to achieve their financial objective. The software application continuously monitors the user's financial activity and progress towards the numerical goal. This includes tracking their savings contributions, income changes, expenses, and other relevant financial transactions. The monitoring is performed periodically to assess the user's financial behavior. The AI model may identify the need to modify the numerical goal based on the monitored user activity. For example, suppose a user initially set a goal to save for a vacation but experiences a significant increase in income. The AI model might recommend a higher savings goal to take advantage of the improved financial situation. As the AI model recommends, any modifications to the numerical goal are displayed on the user's profile page via the user interface. This ensures the user is informed of changes and can adjust their financial planning accordingly.

In one embodiment, based on the user's request and context, the AI model identifies multiple user profiles from the instant solution's data store with similar goals, financial situations, or contexts. These profiles serve as references or sources of inspiration for the numerical goal recommendation. The AI model selects one user profile from the identified profiles that closely aligns with the user's situation. The selection process considers factors like income, expenses, goals achieved, and other relevant attributes. An identifier or summary of the selected user profile is displayed on the user's profile page via the user interface. This gives the user a reference point, allowing them to see how others with similar circumstances have set and achieved their financial goals.

In one embodiment, based on the user's context, the AI model identifies a specific item of purchase or expenditure that aligns with the user's goal. For example, if the user's goal is related to travel, the AI model might identify a vacation package or a particular item, such as an airline ticket, as the focus of the goal. Once the item of purchase is identified, the AI model calculates the recommended numerical goal by considering the associated cost data. This cost data may be ingested from external websites or sources, ensuring the recommendation is based on accurate and up-to-date pricing information.

In one embodiment, the instant solution ingests profile data from one or more websites using APIs. This profile data may include various information related to users, their preferences, interests, or other relevant data points. Once this profile data is collected and stored within a data store, the method proceeds to the next step, which involves displaying one or more prompts on a user interface. These prompts serve as interactive queries or questions presented to users accessing their profile pages within the software application. The purpose of these prompts is to engage users and elicit responses that provide more information about their goals or preferences. The instant solution proceeds to the next phase as users respond to these prompts by providing answers or additional information. An AI model processes this user-generated data. This AI model analyzes the profile data, the prompts displayed, and the responses received. The AI model's role is to make sense of this information and determine a specific goal for the user. This goal may be related to various aspects, such as financial objectives, travel plans, or personal milestones. The determined goal is displayed to the user via the same user interface where the prompts were presented. This allows the user to see and interact with their identified goal within the software application. The goal serves as a personalized recommendation or target based on the information provided by the user and the AI model's analysis.

In one embodiment, the instant solution relies on one or more APIs to ingest data from one or more websites. These APIs facilitate the extraction of architectural data, including images, structural information, and design elements, from various online sources. The data retrieved is then stored within a data store hosted by the host platform. This data store is a repository that accumulates the ingested data for further analysis and design generation. The AI model generates one or more prompts based on the ingested data. These prompts serve as stimuli for the user and play a role in collecting user preferences and design requirements. The prompts are designed to elicit specific responses that will guide the AI model in creating a tailored design. The generated prompts are displayed on the user interface, part of a user profile page within a software application hosted by the host platform. The user interface is the primary interaction between the user and the instant solution. It serves as a communication bridge, presenting prompts to the user and collecting their responses. Upon receiving responses from the user to the displayed prompts, the AI model, using the user input, ingested data, and the prompts, employs this information to generate a design for a structure. This design encompasses architectural aspects, spatial arrangements, aesthetic elements, and more. The design of the structure generated by the AI model is displayed via the same user interface where the prompts were presented. Users can visualize the architectural design and evaluate its alignment with their preferences and requirements.

After data ingestion and prompt generation, the AI model is tasked with creating an image of the architectural structure in one embodiment. This is achieved by leveraging the ingested data, the user's responses to prompts, and the AI's knowledge from analyzing architectural images from various sources. Once the image is generated and sent to the user interface for display, messages exchanged include instructions to the AI model for image generation and the AI's response containing the generated image.

In one embodiment, the instant solution anticipates feedback from the user. This feedback is relayed through the user interface and is then processed by the AI model. Upon receiving feedback, the AI generates additional prompts designed to gather more specific information or preferences from the user. These new prompts are sent to the user interface, where the user responds. Following this interaction, the AI utilizes the responses to modify the existing design. Messages in this context encompass feedback from the user, prompts generated by the AI, and user responses.

In one embodiment, the instant solution, after ingesting user profiles or other relevant data, determines upcoming life milestones for the user. The AI model identifies these milestones based on user data and historical trends. Once identified, the instant solution displays these upcoming life milestones on the user interface, enhancing user engagement and personalization. Messages involve data requests for user profiles, AI-driven milestone identification, and instructions to display milestones on the user interface.

In one embodiment, the AI model, trained in spatial arrangements, colors, and architectural styles, generates images of the interior of the architectural structure. These images are created based on the ingested data from other structures and are displayed as thumbnails on the user profile page's user interface. Messages exchanged include AI instructions for interior image generation and data delivery to populate the user interface with interior design thumbnails. The AI model uses its understanding of architectural styles, colors, and design principles to generate images of the structure's exterior. These exterior images, like the interior ones, are displayed as thumbnails on the user profile page's user interface. Messages include instructions to the AI model for exterior image generation and delivering these images to the user interface. The AI model undergoes rigorous training using historical images of various structures. This training involves understanding spatial arrangements, colors, and architectural styles. The messages in this context encompass data ingestion for historical images, AI model training instructions, and feedback loops for AI model refinement. After generating the design, the instant solution simulates a three-dimensional (3D) view on the user interface. Users can interact with this 3D view by moving the field of view in three dimensions using commands sent through the user interface. Messages include instructions to simulate the 3D view and user commands for manipulating the view.

In one embodiment, the instant solution utilizes historical images of other structures to train the AI model to understand spatial arrangements, colors, and architectural styles. Messages include data payloads containing historical image datasets. The AI model processes this data during training to enhance its understanding of architectural elements. The instant solution simulates a 3D view of the structure's design within the user interface. Messages exchanged include commands from user interactions with the interface, directing the 3D simulation. Based on these commands, the user interface components move the field of view in three dimensions.

In one embodiment, data from one or more websites are ingested via one or more APIs. This task involves components responsible for web scraping or API integration. The messages exchanged are requests to the APIs of various websites to retrieve relevant data. The instant solution receives, parses, and stores the data in a data store within the host platform. The software application hosted by the host platform displays one or more prompts on the user interface of a user profile page. This interaction involves components that render the user interface and generate context-specific prompts. The messages exchanged include instructions to display prompts, and the receiving processors render these prompts on the user's interface. When the user interacts with the prompts and provides responses, the user interface components send these responses back to the software application. Messages here include user responses sent to the receiving processors. These processors then process and forward the responses to the AI model for further analysis. The AI model analyzes website ingested data and user responses and prompts users to create a personalized travel plan. Messages sent in this step include data payloads containing the ingested information, user responses, and prompts. The AI model processes this data and generates the travel itinerary as a digital document, which may include suggested dates, destinations, transportation modes, and image content. The document is then sent back to the user interface components for display. The generated travel itinerary, which may include textual and visual content, is displayed via the user profile page's user interface. Messages exchanged here include instructions to display the itinerary, and the receiving processors within the user interface components render the itinerary for the user to view.

In one embodiment, the instant solution generates a digital document containing details of the travel itinerary, including the suggested travel date, destination, and mode of transportation. This involves the AI model processing ingested website data, user profile information, prompts, and responses. Messages exchanged include data payloads comprising AI instructions and processed data. The AI model generates the digital document, which includes image content, and sends it to the user interface components for display. Components responsible for generating prompts analyze user profiles and ingested data to create context-specific prompts. Messages sent include requests to generate prompts, and the receiving processors within prompt generation components handle the creation of these prompts based on user profiles and ingested data. The instant solution ingests additional data from websites via APIs. Messages include requests to fetch new data. The AI model processes this new data to suggest changes to the travel itinerary. Modified details are returned to the user interface for display, and messages include instructions to update the itinerary. The instant solution receives preference data from user profiles, which helps customize travel itineraries. Messages include data payloads containing user preferences. The AI model processes this information and other data sources to generate a personalized travel plan. When users provide feedback about the travel itinerary, the user interface components send this feedback as messages to the instant solution. The AI model processes the feedback and sends messages back to update the itinerary attributes based on user suggestions. Instructions to modify the itinerary are sent to the user interface for display.

The AI model in the instant solution utilizes received data in a multi-step process to transform it into actionable recommendations. For financial goal setting, the AI model begins by analyzing the user's profile data, including income, expenses, savings, and existing financial goals. Simultaneously, it taps into external financial data sources through APIs to gather real-time information on account balances, investment portfolios, and transaction history. The combining of user-specific and real-time data enables the generation of personalized financial goals. The AI model employs complex algorithms to assess the user's financial health, considering factors like income trends, spending patterns, and asset performance. It then calculates recommended financial goals such as savings targets, investment strategies, and debt repayment plans tailored to the user's current financial situation. For travel planning, the AI model starts by processing user preferences, travel destination choices, and budget constraints. It communicates with external data sources via APIs to retrieve real-time information on flight prices, hotel availability, and local events. The AI model synthesizes this data to create personalized travel itineraries, including suggested travel dates, transportation modes, and activity recommendations. It considers the user's preferences and the dynamic nature of travel-related information, ensuring that the recommendations are always up-to-date and aligned with the user's interests.

The AI model remains adaptable and responsive to user feedback and adjustments throughout both financial and travel-related processes. It actively incorporates user interactions with the software application, whether modifying financial goals or refining travel plans based on user preferences. This continuous feedback loop enables the AI model to refine its recommendations, ensuring they remain relevant and personalized. In summary, the AI model is the intelligence behind the instant solution. It uses data transformation, real-time updates, and user interactions to provide users with dynamic and customized financial goals and travel itineraries that adapt to their evolving needs and circumstances.

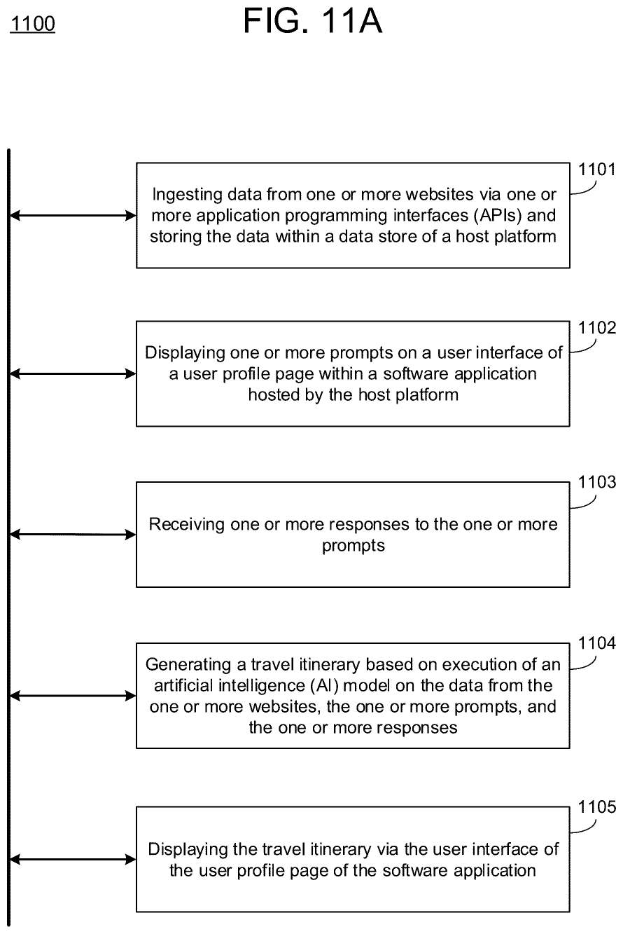

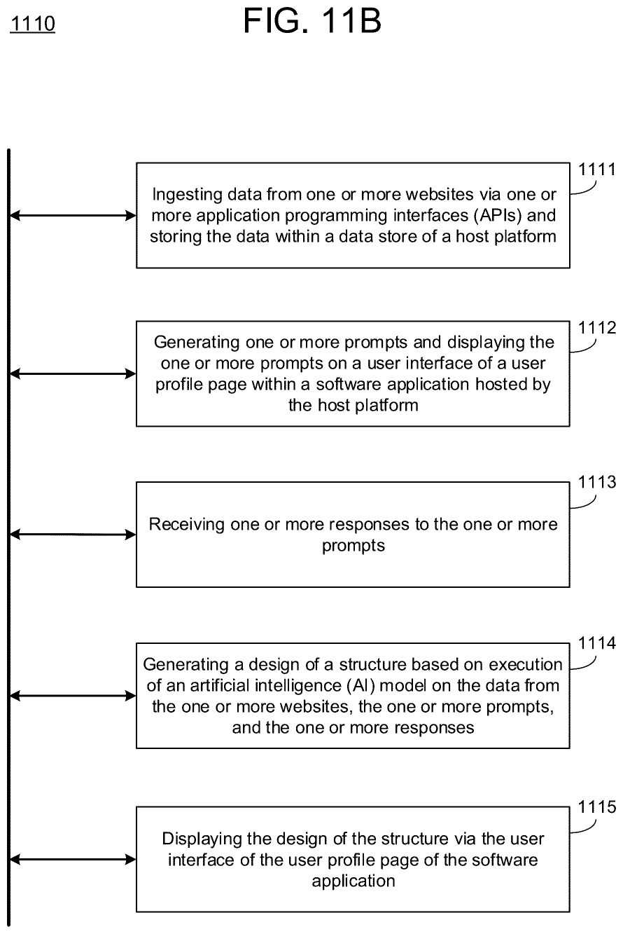

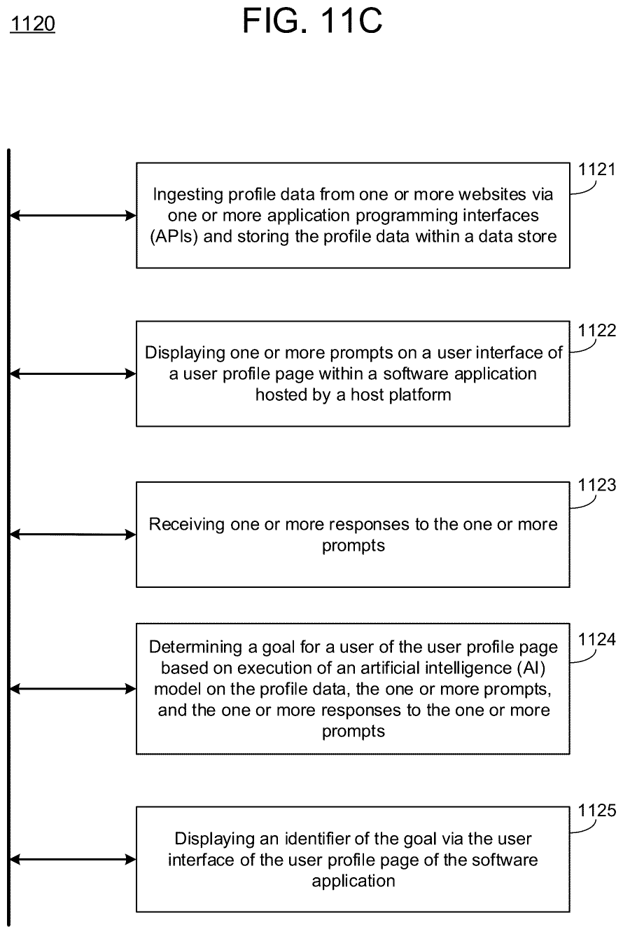

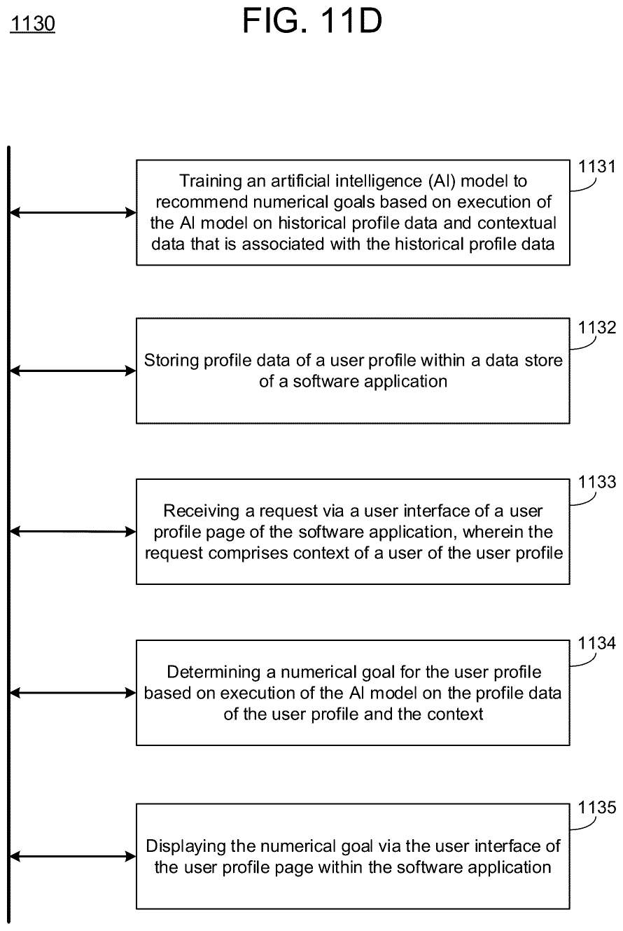

FIG. 11A illustrates a method 1100 of generating a travel itinerary through artificial intelligence according to example embodiments. For example, the method 1100 may be performed by a host platform such as a web server, cloud platform, on-premises server, or the like. Referring to FIG. 11A, in 1101, the method may include ingesting data from one or more websites via one or more application programming interfaces (APIs) and storing the data within a data store of a host platform. In 1102, the method may include displaying one or more prompts on a user interface of a user profile page within a software application hosted by the host platform. In 1103, the method may include receiving one or more responses to the one or more prompts. In 1104, the method may include generating a travel itinerary based on execution of an artificial intelligence (AI) model on the data from the one or more websites, the one or more prompts, and the one or more responses. In 1105, the method may include displaying the travel itinerary via the user interface of the user profile page of the software application.

FIG. 11B illustrates a method 1110 of generating a structural design through artificial intelligence according to example embodiments. For example, the method 1110 may be performed by a host platform such as a web server, cloud platform, on-premises server, or the like. Referring to FIG. 11B, in 1111, the method may include ingesting data from one or more websites via one or more application programming interfaces (APIs) and storing the data within a data store of a host platform. In 1112, the method may include generating one or more prompts and displaying the one or more prompts on a user interface of a user profile page within a software application hosted by the host platform. In 1113, the method may include receiving one or more responses to the one or more prompts. In 1114, the method may include generating a design of a structure based on execution of an artificial intelligence (AI) model on the data from the one or more websites, the one or more prompts, and the one or more responses. In 1115, the method may include displaying the design of the structure via the user interface of the user profile page of the software application.

FIG. 11C illustrates a method 1120 of generating a description of a goal according to example embodiments. For example, the method 1120 may be performed by a host platform such as a web server, cloud platform, on-premises server, or the like. Referring to FIG. 11C, in 1121, the method may include ingesting profile data from one or more websites via one or more application programming interfaces (APIs) and storing the profile data within a data store. In 1122, the method may include displaying one or more prompts on a user interface of a user profile page within a software application hosted by a host platform. In 1123, the method may include receiving one or more responses to the one or more prompts. In 1124, the method may include determining a goal for a user of the user profile page based on execution of an artificial intelligence (AI) model on the profile data, the one or more prompts, and the one or more responses to the one or more prompts. In 1125, the method may include displaying an identifier of the goal via the user interface of the user profile page of the software application.

FIG. 11D illustrates a method 1130 of generating a numerical goal according to example embodiments. For example, the method 1130 may be performed by a host platform such as a web server, cloud platform, on-premises server, or the like. Referring to FIG. 11D, in 1131, the method may include training an artificial intelligence (AI) model to recommend numerical goals based on execution of the AI model on historical profile data and contextual data that is associated with the historical profile data. In 1132, the method may include storing profile data of a user profile within a data store of a software application. In 1133, the method may include receiving a request via a user interface of a user profile page of the software application, wherein the request comprises context of a user of the user profile. In 1134, the method may include determining a numerical goal for the user profile based on execution of the AI model on the profile data of the user profile and the context. In 1135, the method may include displaying the numerical goal via the user interface of the user profile page within the software application.

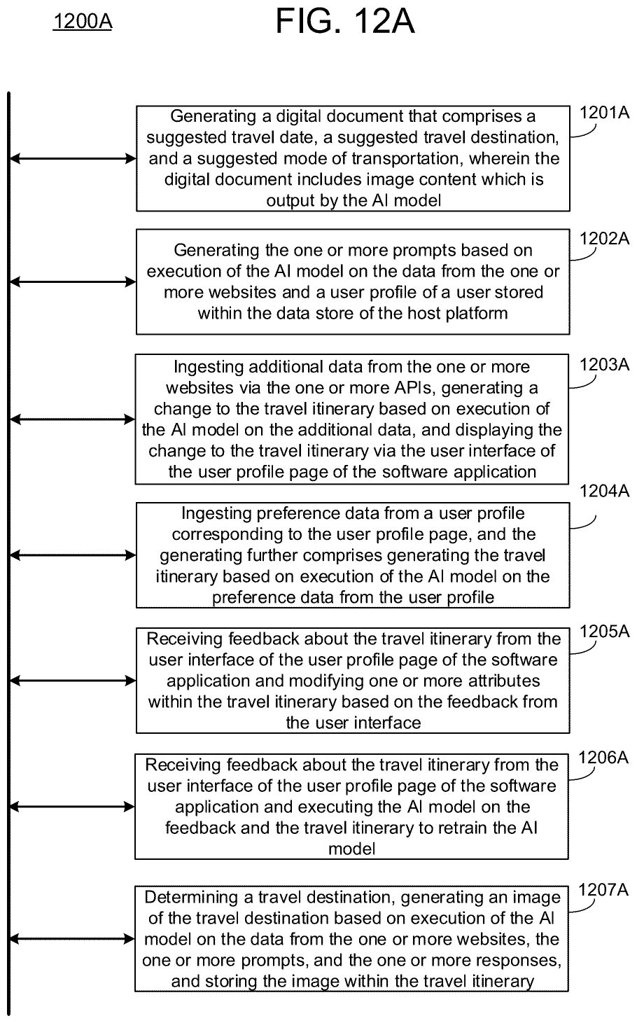

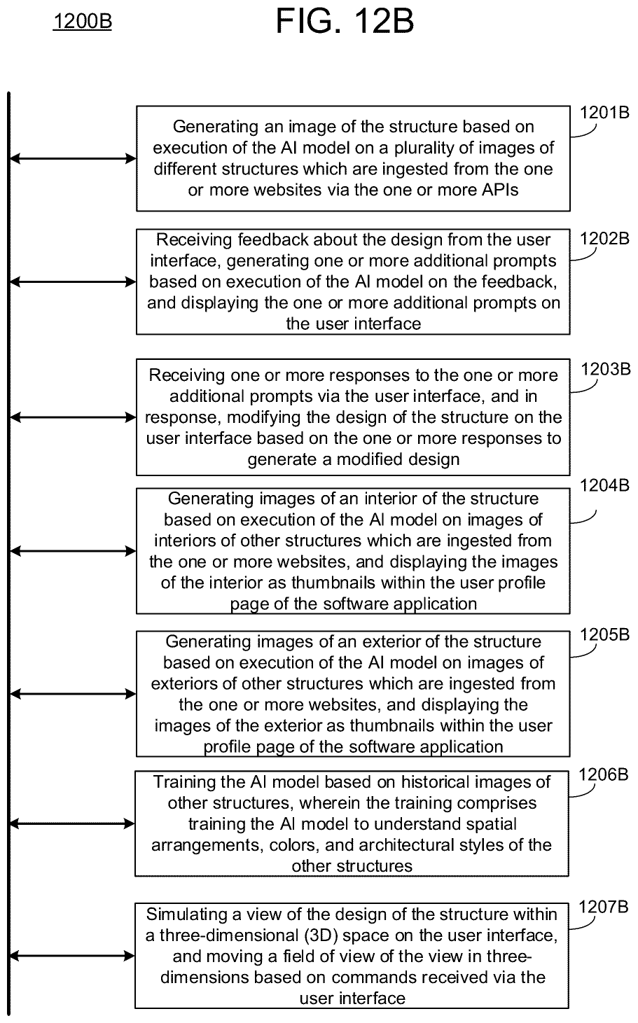

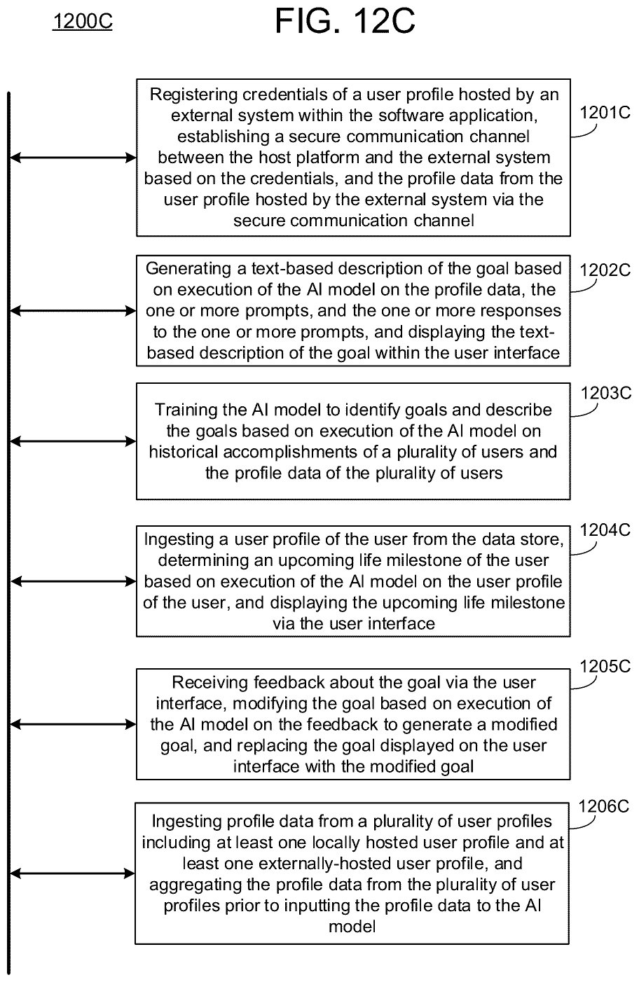

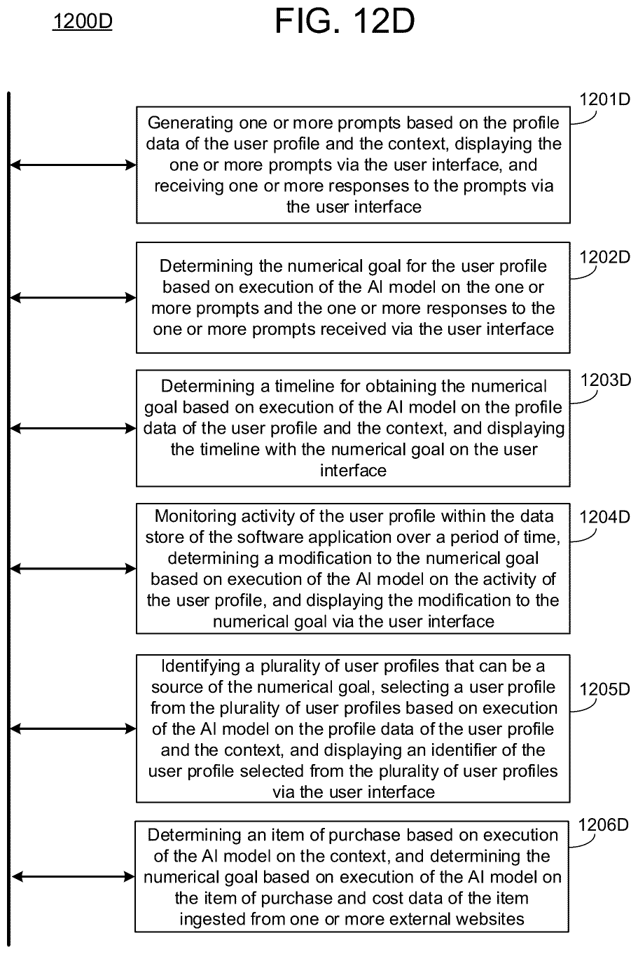

FIG. 12A illustrates a flow diagram for method 1200A, according to example embodiments. As an example, the method 1200A may be performed by a computing system, a software application, a server, a cloud platform, a combination of systems, and the like. Referring to FIG. 12A, in 1201A, the method may include generating a digital document that comprises a suggested travel date, a suggested travel destination, and a suggested mode of transportation, wherein the digital document includes image content which is output by the AI model. In 1202A, the method may include generating the one or more prompts based on execution of the AI model on the data from the one or more websites and a user profile of a user stored within the data store of the host platform. In 1203A, the method may include ingesting additional data from the one or more websites via the one or more APIs, generating a change to the travel itinerary based on execution of the AI model on the additional data, and displaying the change to the travel itinerary via the user interface of the user profile page of the software application. In 1204A, the method may include ingesting preference data from a user profile corresponding to the user profile page, and the generating further comprises generating the travel itinerary based on execution of the AI model on the preference data from the user profile. In 1205A, the method may include receiving feedback about the travel itinerary from the user interface of the user profile page of the software application and modifying one or more attributes within the travel itinerary based on the feedback from the user interface. In 1206A, the method may include receiving feedback about the travel itinerary from the user interface of the user profile page of the software application and executing the AI model on the feedback and the travel itinerary to retrain the AI model. In 1207A, the method may include determining a travel destination, generating an image of the travel destination based on execution of the AI model on the data from the one or more websites, the one or more prompts, and the one or more responses, and storing the image within the travel itinerary.

FIG. 12B illustrates another flow diagram for method 1200B, according to example embodiments. As an example, the method 1200B may be performed by a computing system, a software application, a server, a cloud platform, a combination of systems, and the like. Referring to FIG. 12B, in 1201B, the method may include generating an image of the structure based on execution of the AI model on a plurality of images of different structures which are ingested from the one or more websites via the one or more APIs. In 1202B, the method may include receiving feedback about the design from the user interface, generating one or more additional prompts based on execution of the AI model on the feedback, and displaying the one or more additional prompts on the user interface. In 1203B, the method may include receiving one or more responses to the one or more additional prompts via the user interface, and in response, modifying the design of the structure on the user interface based on the one or more responses to generate a modified design. In 1204B, the method may include generating images of an interior of the structure based on execution of the AI model on images of interiors of other structures which are ingested from the one or more websites, and displaying the images of the interior as thumbnails within the user profile page of the software application. In 1205B, the method may include generating images of an exterior of the structure based on execution of the AI model on images of exteriors of other structures which are ingested from the one or more websites, and displaying the images of the exterior as thumbnails within the user profile page of the software application. In 1206B, the method may include training the AI model based on historical images of other structures, wherein the training comprises training the AI model to understand spatial arrangements, colors, and architectural styles of the other structures. In 1207B, the method may include simulating a view of the design of the structure within a three-dimensional (3D) space on the user interface, and moving a field of view of the view in three-dimensions based on commands received via the user interface.

FIG. 12C illustrates another flow diagram for method 1200C, according to example embodiments. As an example, the method 1200C may be performed by a computing system, a software application, a server, a cloud platform, a combination of systems, and the like. Referring to FIG. 12C, in 1201C, the method may include registering credentials of a user profile hosted by an external system within the software application, establishing a secure communication channel between the host platform and the external system based on the credentials, and the profile data from the user profile hosted by the external system via the secure communication channel. In 1202C, the method may include generating a text-based description of the goal based on execution of the AI model on the profile data, the one or more prompts, and the one or more responses to the one or more prompts, and displaying the text-based description of the goal within the user interface. In 1203C, the method may include training the AI model to identify goals and describe the goals based on execution of the AI model on historical accomplishments of a plurality of users and the profile data of the plurality of users. In 1204C, the method may include ingesting a user profile of the user from the data store, determining an upcoming life milestone of the user based on execution of the AI model on the user profile of the user, and displaying the upcoming life milestone via the user interface. In 1205C, the method may include receiving feedback about the goal via the user interface, modifying the goal based on execution of the AI model on the feedback to generate a modified goal, and replacing the goal displayed on the user interface with the modified goal. In 1206C, the method may include ingesting profile data from a plurality of user profiles including at least one locally hosted user profile and at least one externally-hosted user profile, and aggregating the profile data from the plurality of user profiles prior to inputting the profile data to the AI model.

FIG. 12D illustrates another flow diagram for method 1200D, according to example embodiments. As an example, the method 1200D may be performed by a computing system, a software application, a server, a cloud platform, a combination of systems, and the like. Referring to FIG. 12D, in 1201D, the method may include generating one or more prompts based on the profile data of the user profile and the context, displaying the one or more prompts via the user interface, and receiving one or more responses to the prompts via the user interface. In 1202D, the method may include determining the numerical goal for the user profile based on execution of the AI model on the one or more prompts and the one or more responses to the one or more prompts received via the user interface. In 1203D, the method may include determining a timeline for obtaining the numerical goal based on execution of the AI model on the profile data of the user profile and the context, and displaying the timeline with the numerical goal on the user interface. In 1204D, the method may include monitoring activity of the user profile within the data store of the software application over a period of time, determining a modification to the numerical goal based on execution of the AI model on the activity of the user profile, and displaying the modification to the numerical goal via the user interface. In 1205D, the method may include identifying a plurality of user profiles that can be a source of the numerical goal, selecting a user profile from the plurality of user profiles based on execution of the AI model on the profile data of the user profile and the context, and displaying an identifier of the user profile selected from the plurality of user profiles via the user interface. In 1206D, the method may include determining an item of purchase based on execution of the AI model on the context, and determining the numerical goal based on execution of the AI model on the item of purchase and cost data of the item ingested from one or more external websites.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), digital versatile disc read-only memory (“DVD-ROM”) or any other form of storage medium known in the art.

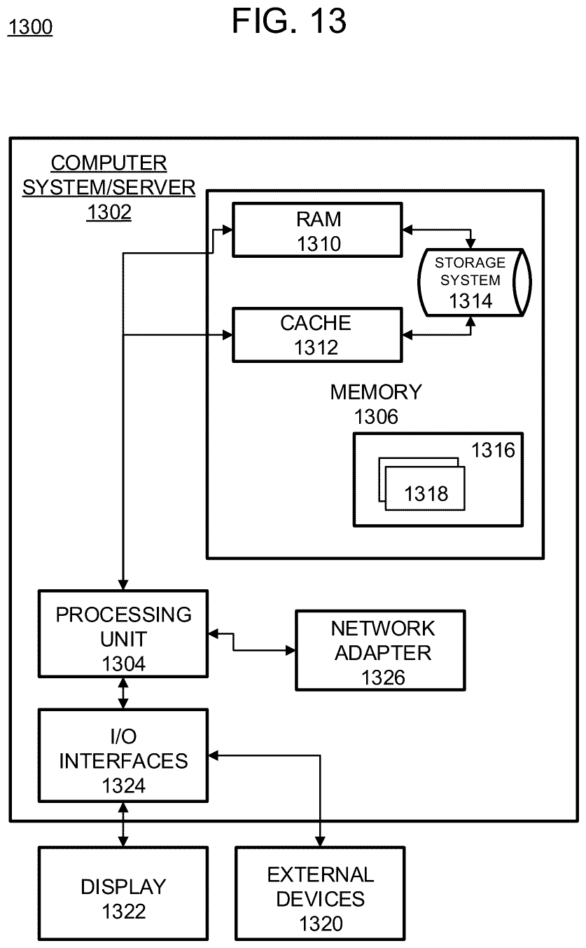

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 13 illustrates an example computer system architecture, which may represent or be integrated in any of the above-described components, etc.

FIG. 13 illustrates an example system 1300 that supports one or more of the example embodiments described and/or depicted herein. The system 1300 comprises a computer system/server 1302, which is operational with numerous other general purpose or special purpose computing system environments or configurations. Examples of well-known computing systems, environments, and/or configurations that may be suitable for use with computer system/server 1302 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1302 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1302 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 31, computer system/server 1302 in the example system 1300 is shown in the form of a general-purpose computing device. The components of computer system/server 1302 may include, but are not limited to, one or more processors or processing units (processor 1304), a system memory 1306, and a bus that couples various system components including the system memory 1306 to the processor 1304.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1302 typically includes a variety of computer system readable media. Such media may be any available media that is accessible by computer system/server 1302, and it includes both volatile and non-volatile media, removable and non-removable media. The system memory 1306, in one embodiment, implements the flow diagrams of the other figures. The system memory 1306 can include computer system readable media in the form of volatile memory, such as RAM 1310 and/or cache memory 1312. Computer system/server 1302 may further include other removable/non-removable, volatile/non-volatile computer system storage media. By way of example only, storage system 1314 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, the system memory 1306 may include at least one program product having a set (e.g., at least one) of program modules that are configured to carry out the functions of various embodiments of the application.

Program/utility 1316, having a set (at least one) of program modules 1318, may be stored in the system memory 1306 by way of example, and not limitation, as well as an operating system, one or more application programs, other program modules, and program data. Each of the operating system, one or more application programs, other program modules, and program data or some combination thereof, may include an implementation of a networking environment. Program modules 1318 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 1302 may also communicate with one or more external devices 1320 such as a keyboard, a pointing device, a display 1322, etc.; one or more devices that enable a user to interact with computer system/server 1302; and/or any devices (e.g., network card, modem, etc.) that enable computer system/server 1302 to communicate with one or more other computing devices. Such communication can occur via input/output (I/O) interfaces 1324. Still yet, computer system/server 1302 can communicate with one or more networks such as a local area network (LAN), a general wide area network (WAN), and/or a public network (e.g., the Internet) via network adapter 1326. As depicted, network adapter 1326 communicates with the other components of computer system/server 1302 via a bus. It should be understood that although not shown, other hardware and/or software components may be used in conjunction with computer system/server 1302. Examples, include, but are not limited to: microcode, device drivers, redundant processing units, external disk drive arrays, redundant array of independent disks (RAID) systems, tape drives, and data archival storage systems, etc.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” may be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

1. An apparatus comprising:
a memory; and
a processor communicably coupled to the memory, the processor configured to:
ingest data from one or more websites via one or more application programming interfaces (APIs) and store the data within a data store, identify a description of an objective from the data;
display one or more queries on a graphical user interface of a page within a software application-hosted by a host platform,
receive one or more responses to the one or more queries via the graphical user interface,
execute a multi-modal artificial intelligence (AI) model on the description of the objective, the one or more queries, and the one or more responses to the one or more queries to generate a custom image of the objective which includes visual content of the objective, wherein the multi-modal AI model is trained to learn mappings between image content and text content, and
render the custom image via the graphical user interface of the user profile page of the software application.

2. The apparatus of claim 1, wherein the processor is further configured to register credentials of a user profile hosted by an external system within the software application, establish a secure communication channel between a host of the software application and the external system based on the credentials, and ingest the data from the user profile hosted by the external system via the secure communication channel.

3. The apparatus of claim 1, wherein the processor is configured to generate the one or more queries based on the execution of the multi-modal AI model.

4. The apparatus of claim 1, wherein the objective comprises a physical object, and the processor is configured to generate a unique image of the physical object based on the execution of the multi-modal AI model.

5. The apparatus of claim 1, wherein the processor is configured to ingest a user profile of a user from the data store, determine an upcoming milestone of the user based on execution of the multi-modal AI model on the user profile of the user, and display the upcoming milestone via the graphical user interface.

6. The apparatus of claim 1, wherein the processor is further configured to receive feedback about the objective via the graphical user interface, modify the objective based on execution of the multi-modal AI model on the feedback to generate a modified objective, and display an identifier of the modified objective on the graphical user interface.

7. The apparatus of claim 1, wherein the processor is configured to ingest profile data from a plurality of profiles including at least one locally hosted profile and at least one externally-hosted profile, and aggregate the profile data from the plurality of profiles prior to inputting the profile data to the multi-modal AI model.

8. A method comprising:
ingesting data from one or more websites via one or more application programming interfaces (APIs) and storing the data within a data store;
identifying a description of an objective from the data;
displaying one or more queries on a graphical user interface of a page within a software application;
receiving one or more responses to the one or more queries;
executing a multi-modal artificial intelligence (AI) model on the description of the objective, the one or more queries, and the one or more responses to the one or more queries to generate a custom image of the objective which includes visual content of the objective, wherein the multi-modal AI model is trained to learn mappings between image content and text content; and
rendering the custom image via the graphical user interface of the page of the software application.

9. The method of claim 8, wherein the method further comprises registering credentials of a user profile hosted by an external system within the software application, establishing a secure communication channel between a host of the software application and the external system based on the credentials, and ingest the data from the user profile hosted by the external system via the secure communication channel.

10. The method of claim 8, wherein the displaying the one or more queries comprises generating the one or more queries based on the execution of the multi-modal AI model.

11. The method of claim 8, wherein the objective comprises a physical object and the method further comprises generating a unique image of the physical object based on the execution of the multi-modal AI model.

12. The method of claim 8, wherein the method further comprises ingesting a user profile of a user from the data store, determining an upcoming milestone of the user based on execution of the multi-modal AI model on the user profile of the user, and displaying the upcoming milestone via the graphical user interface.

13. The method of claim 8, wherein the method further comprises receiving feedback about the objective via the graphical user interface, modifying the objective based on execution of the multi-modal AI model on the feedback to generate a modified objective, and displaying the modified objective via the graphical user interface.

14. The method of claim 8, wherein ingesting the data comprises ingesting profile data from a plurality of user profiles including at least one locally hosted user profile and at least one externally-hosted user profile, and aggregating the profile data from the plurality of user profiles prior to inputting the profile data to the AI model.

15. A computer-readable storage medium comprising instructions stored therein which when executed by a processor cause the processor to perform:
ingesting data from one or more websites via one or more application programming interfaces (APIs) and storing the data within a data store;
identify a description of an objective from the data;
displaying one or more queries on a graphical user interface of a page within a software application;
receiving one or more responses to the one or more queries via the graphical user interface;
executing a multi-modal artificial intelligence (AI) model on the description of the objective, the one or more queries, and the one or more responses to the one or more queries to generate a custom image of the objective which includes visual content of the objective, wherein the multi-modal AI model is trained to learn mappings between image content and text content; and
render the custom image via the graphical user interface of the page of the software application.

16. The computer-readable storage medium of claim 15,
wherein the processor is further configured to perform registering credentials of a user profile hosted by an external system within the software application, establishing a secure communication channel between a host of the software application and the external system based on the registered credentials, and ingesting the data from the user profile hosted by the external system via the secure communication channel.

17. The computer-readable storage medium of claim 15, wherein the displaying the one or more queries comprises generating the one or more queries based on the execution of the multi-modal AI model.

18. The computer-readable storage medium of claim 15, wherein the objective comprises a physical object, and the processor is configured to generate a unique image of the physical object based on the execution of the multi-modal AI model.

19. The computer-readable storage medium of claim 15, wherein the processor is further configured to perform ingesting a user profile of a user from the data store, determining an upcoming milestone of the user based on execution of the multi-modal AI model on the user profile, and displaying the upcoming milestone via the graphical user interface.

20. The computer-readable storage medium of claim 15, wherein the processor is further configured to perform receiving feedback about the objective via the graphical user interface, modifying the objective based on execution of the multi-modal AI model on the received feedback, and displaying the modified objective via the graphical user interface.
